(19) United States
(12) Patent Application Publication
(10) Pub. No.: US 2010/0165215 A1
(43) Pub. Date: Jul. 1, 2010

(54) Communication control systems and methods

(76) Inventor: Youngtack Shim, Port Moody (CA)

Correspondence Address: Youngtack Shim, 155 Aspenwood Drive, Port Moody, BC, V3H 5A5, CA

(21) Appl. No.: 12/318,536

(22) Filed: Dec. 31, 2008

(51) Int. Cl. H04N 5/44

(52) U.S. Cl. 348/734; 348/E05.096

(57) ABSTRACT

The present invention generally relates to various communication control systems capable of controlling operations of their target modules with their control modules. More particularly, the present invention relates various communication control systems including control modules and target modules and capable of controlling various operations of the target models with the control modules wirelessly. To this end, the control and target modules are preferably provided with various transmitters as well as receivers for receiving user inputs by the control modules, converting the user inputs to command signals, transmitting the command signals to the target modules, and then controlling the operations of the target module accordingly. The present invention also relates to various methods of controlling the operations of the target modules of the communication control systems with the control modules of the system wirelessly and various methods of receiving the user inputs, converting the user inputs to the command signals, transmitting the command signals to the target modules, and recognizing the signals by the target modules. The present invention further relates to various processes for providing such communication systems and various control and target modules thereof.

### CROSS-REFERENCES TO RELATED APPLICATIONS

The present application claims an earlier invention date of the Disclosure Document entitled the same, deposited in the U.S. Patent and Trademark Office (the “Office”) on Jan. 3, 2007 under the Disclosure Document Deposit Program (the “DDDP”) of the Office, and which bears the Ser. No. 610,801 an entire portion of which is incorporated herein by reference.

### FIELD OF THE INVENTION

The present invention generally relates to various communication control systems capable of controlling operations of their target modules with their control modules. More particularly, the present invention relates various communication control systems including control modules and target modules and capable of controlling various operations of the target models with the control modules wirelessly. To this end, the control and target modules are preferably provided with various transmitters as well as receivers for receiving user inputs by the control modules, converting the user inputs to command signals, transmitting the command signals to the target modules, and then controlling the operations of the target module accordingly. The present invention also relates to various methods of controlling the operations of the target modules of the communication control systems with the control modules of the system wirelessly and various methods of receiving the user inputs, converting the user inputs to the command signals, transmitting the command signals to the target modules, and recognizing the signals by the target modules. The present invention further relates to various processes for providing such communication systems and various control and target modules thereof.

### BACKGROUND OF THE INVENTION

With the advent of semiconductor technologies, numerous electric devices enjoy popular uses both in workplaces and at homes. All of such devices are designed to perform a myriad of different functions and, therefore, provided with numerous input means such as switches, keys, displays, and touch screens. To provide further convenience to the users, many of the devices are equipped with receivers capable of wirelessly receiving various command signals issued by remote controllers and performing specific functions based on the command signals.

Although these remotely controllable electric devices offer clear benefits, abundance of such devices current reach a point where the benefits are turning into nuisance. For example, an average household is currently equipped with a television set, a CD player, and a DVD player, to say the least. Some households are even equipped with additional remotely controllable electric devices such as an air conditioner, an electric heater, an air cleaner, and so on. As a result, it is a common scene to find several remote controllers stacked on a table and a person (sometimes an owner of the house) has to waste time and efforts while juggling around different remote controller for identifying the right one to control a desired electric device.

With the advent of wireless communication technologies, almost all adults in many developed countries carry wireless mobile (or cellular) phones. There even is a trend that people replace those old-fashioned wired communication with their mobile phones in their residences. Accordingly, people keep their mobile phones in their residences, answer the mobile phones off their works, and carry the mobile phones to their beds. It is, therefore, presumed that these people get used to various functions of their phones and various input configurations with which they type in various command signals into the phones. Despite their popular uses, current mobile phones are strictly limited to only a handful of specific functions, namely, communicating with a third party either directly or through a communication provider, downloading various audio and/or video informations through the provider or an internet, and the like. Despite their abundance of frequent uses, these mobile phones are functionally coupled with those household electric devices.

Therefore, there is an urgent need for a communication control system allowing its user to not only communicate with the third party therewith but also control operations of such household electric devices therewith wirelessly. As a result, there is a need for various communication devices capable of transmitting the command signals to the electric devices and for various electric devices capable of receiving and recognizing the command signals transmitted by the communication devices. There also is a need for various transmitters, receivers, and even optional converters for allowing such wireless transmission of the command signals from the communication devices to the electric devices.

### SUMMARY OF THE INVENTION

The present invention generally relates to a communication control system which includes at least one control module and at least one target module and which is capable of wirelessly controlling various operations of the target module by the control module. More particularly, the present invention relates a communication control system including at least one prior art wireless communication device as its control module and at least one prior art household electric device as its target module and then allows wireless transmission of various command signals from the control module to the target module in order to control various operations of the target module. To this end, the control and target modules are preferably provided with various transmitters as well as receivers for receiving user inputs by the control modules, converting the user inputs to the command signals, transmitting the command signals to the target modules, and then recognizing and controlling the operations of the target module based on such command signals. The present invention, accordingly, relates to the control module including various transmitters capable of transmitting electromagnetic waves of a variety of frequency ranges which may be received and then recognized by the target module, and to the target module including various receivers capable of receiving and recognizing such electromagnetic waves defining various frequency ranges. The present invention further relates to the control modules provided with various input configurations not only for communicating with a third party as a wireless communication device but also for controlling the operations of the target module as a controller therefor.

The present invention relates to various methods of wirelessly controlling operation of a target module of a communication control system by a control module thereof. More particularly, the present invention relates to various methods of providing the communication control system by pairing at least one prior art wireless communication device which is to be utilized as a control module of the system with at least one prior art household electric device which is to be used as a target module of such a system, and then modifying at least one of the modules (or devices) for establishing various wireless control means from the control module to the target module. To this end, the present invention relates to various methods of incorporating into the control module various transmitters capable of transmitting electromagnetic waves of preset frequencies, various methods of incorporating into the target module various receivers capable of receiving and then recognizing command signals carried by the waves, various methods of modifying preexisting transmitters of the control module therefor, various methods of modifying preexisting receivers of the target module therefor, various methods of incorporating into the control module additional transmitters therefor, various methods of incorporating into such a target module additional receivers therefor, various methods of converting the waves of preset frequencies generated by the preexisting transmitters into other waves of different frequencies recognizable by the receivers and then transmitting such converted waves to the target module, and various methods of receiving the waves of preset frequencies from the control module, converting those waves into other waves of different frequencies, and then delivering the converted waves to the target module. The present invention also relates to various methods of receiving various user inputs for not only the communicating with the third party but also for such controlling using a single input unit of the control module, various methods of receiving the user inputs for such communication with one input unit and receiving different user inputs for the controlling with another input unit, and the like.

The present invention also relates to various processes for providing a communication control system including at least one control module and at least one target module, and capable of wirelessly controlling various operations of the target module by such a control module. In particular, the present invention relates to various processes for including at least one conventional wireless communication device as a control module of the system and including at least one prior art household electric device as its target module and then establishing wireless transmission of various command signals from the control module to the target module in order to control various operations of the target module. To this end, the present invention relates to various processes for providing the control module with at least one transmitter and also providing the target module with at least one receiver, various processes for providing the control module capable of transmitting the command signals receivable and recognizable by the target module, various processes for providing the target module capable of receiving and then recognizing the command signals emitted by the control module, and various processes of fabricating the target module to control its operations based on such command signals. Accordingly, the present invention also relates to various processes for providing various transmitters capable of transmitting electromagnetic waves of a variety of frequency ranges receivable and recognizable by the target module, and various processes for providing various receivers capable of receiving and recognizing such waves, and the like. The present invention also relates to various processes for providing such control modules with various input configurations not only for communicating with a third party while functioning as the wireless communication device but also for controlling the operations of the target module as the controller therefor.

Accordingly, a primary objective of the present invention is to provide a communication control system including at least one control module and at least one target module and capable of wirelessly controlling operations of the target module using the control module which is also capable of providing wireless communication between an user of such a system and a third party directly therebetween or through a communication provider. Therefore, a related objective of this invention is to fabricate such a control module from various prior art wireless communication devices. Another related objective of this invention is to fabricate such a target module from various remotely controllable prior art electric devices.

Another objective of the present invention is to provide a communication control system which includes various prior art wireless communication devices as its control modules and various prior art remotely controllable electric devices as its target modules and then which is also arranged to modify at least one of such devices modules for controlling the operations of the target module by the control module. Therefore, a related objective of this invention is to use the prior art wireless communication devices as the control modules without modification thereof, while using the remotely controllable prior art electric devices as the target modules after modification thereof. Another related objective of this invention is to employ the conventional wireless communication devices as such control modules after modification thereof, while using the remotely controllable conventional electric devices as such target modules without modification thereof. Another related objective of this invention is to use the prior art wireless communication devices as such control modules after their modification, while employing the remotely controllable prior art electric devices as the target modules thereof after modification thereof.

Another objective of the present invention is to provide a communication control system which includes various prior art wireless communication devices and remotely controllable electric devices as the control and target modules while modifying at least one of such devices. Therefore, a related objective of this invention is to provide such control modules from various prior art mobile (or cellular) phones, PDA's, and other wireless information processing devices, where such information includes, but not limited to, text information, audio (or audible) information, video (or picture) information, and the like. Another related objective of this invention is to provide the target modules from various remotely controllable prior art electric devices examples of which include, but not limited to, storage devices of such information, processing devices of such information, display (and/or playing) devices for such information, security devices, transportation devices such as automobiles, motorcycles, helicopters, airplanes, and surface vessels, lighting devices, household devices such as humidifiers, air cleaners, heaters, and air conditioners, other remotely controllable electric devices, and so on. Another related objective of this invention is to provide the communication control system by modifying at least one of such modules to allow the control module to remotely control the target module.

Another objective of the present invention is to provide a communication control system which is capable of controlling operations of its target module by its control module while resorting to various communication capabilities of a prior art communication device of such a control module. Accordingly, a related objective of this invention is to provide the control module for controlling the operations of the target module by emitting radio waves or microwaves to the target module. Another related objective of this invention is to provide such a control module for controlling the operations of the target module by emitting infrared waves thereto. Another related objective of this invention is to provide the control module capable of controlling such operations of the target module by emitting electromagnetic waves of frequencies other than the radio waves, microwaves, and infrared waves thereto.

Another objective of the present invention is to provide a communication control system which is capable of emitting various electromagnetic waves of such frequencies using various transmitters. Accordingly, a related objective of this invention is to include in the control module a single transmitter capable of transmitting the electromagnetic waves not only for communicating with the third party but also for controlling the operations of the target module. Another related objective of this invention is to provide the control module with a transmitter capable of emitting the electromagnetic waves of preset frequencies for communicating with the third party and yet another transmitter capable of emitting the waves of different frequencies for controlling such operations of the target module. Another related objective of this invention is to provide the control module with a converter capable of changing such frequencies of the waves emitted by a single transmitter and then transmitted therethrough. Another related objective of this invention is to incorporate into the control module a single universal transmitter and a converter such that the transmitter emits the electromagnetic waves of preset frequencies and that the converter manipulates frequencies of such waves into first frequencies for communicating with the third party or into second frequencies for controlling the operations of the target module.

Another objective of the present invention is to provide a communication control system which includes therein various input units capable of receiving user inputs for its control module. Therefore, a related objective of this invention is to incorporate in the control module a single input unit capable of receiving user inputs not only for communicating with the third party but also for controlling operations of the target module. Another related objective of this invention is to incorporate in the control module an input unit for receiving the user inputs for communicating with the third party and another input unit for receiving the user inputs for controlling operations of the target module. Another related objective of this invention is to provide the control module with multiple keys and to receive such user inputs by monitoring input signals applied to such keys. Another related objective of this invention is to provide the control module with a display and to receive the user inputs by monitoring an icon provided on the display and selected by the user. Another related objective of this invention is to provide the control module with a touch screen and to receive such user inputs by monitoring the input signals applied to a specific portion of the screen.

Another objective of the present invention is to provide a communication control system with a control module which includes various input units capable of receiving user inputs for communicating with the third party and for controlling operations of the target module. Therefore, a related objective of this invention is to provide the control module with a key-type input unit for such communication and another key-type input module for the control. Another related objective of this invention is to provide the control module with a display-type input unit for the communication and another display-type input unit for the control. Another related objective of this invention is to provide the control module with a touch screen-type input unit for the communication and another touch screen-type input unit for such control. Another related objective of this invention is to provide such a control module with one of the key-type, display-type, and touch screen-type input unit for the communication and a different one of the key-type, display-type, and touch screen-type input unit for such control.

Another objective of the present invention is to provide a communication control system which includes a control module provided with a first input configuration for receiving user inputs designated solely for communicating with the third party and a second input configuration for receiving other user inputs designated solely for controlling operations of the target module. Therefore, a related objective of this invention is to provide both of the first and second input configurations to various input units of the control module by assigning various labels or markings to the input units. Another related objective of this invention is to provide both of such input configurations to the input units but fabricate the input units to exhibit only one of such first and second input configurations at a time depending on whether the user intends to communicate with the third party or to control the operations of the target module, by assigning different sets of labels to the input units but displaying such sets of labels one at a time. Another related objective of this invention is to provide the input configuration for such communication to one set of multiple input units and then to provide the input configuration for such control to another set of such input units.

Another objective of the present invention is to provide a communication control system which includes a control module provided with various input configurations for communicating with the third party and for controlling operations of the target module through various means. Therefore, a related objective of this invention is to store a priori various input configurations of multiple target modules in the control module and then to select one of the input configurations when the user intends to control a target module with the control module. Another related objective of this invention is to download the input configuration of the target module into the control module from various information storage media such as magnetic storage media and optical storage media. Another related objective of this invention is to download the input configuration of the target module into the control module through an internet. Another related objective of this invention is to receive the input configuration of the target module into the control module from the target module wirelessly or through wire. Another related objective of this invention is to display the input configuration of the target module on the control module only during a period in which the user intends to control operations of the target module with the control module.

It is appreciated in all of such objectives that the communication control systems of the present invention are to be preferably fabricated without excessive modifications of various prior art wireless communication devices for providing the above control modules and without excessive modification of various prior art remotely controllable electric devices for providing such target modules. Accordingly, only the control modules may be modified to transmit the command signals which may be received and recognized by the prior art target modules which may not be modified or, alternatively, only the target modules may be modified in order to receive the command signals which are transmitted by the control modules which may not be modified. When desirable or necessary, both of such prior art control and target modules may be modified in order to allow transmission of the command signals from the control modules to the target modules or, alternatively, to allow communication between such modules.

A variety of apparatus, method, and process aspects of such communication control systems and their various embodiments are to be now enumerated. It is appreciated, however, that following system, method, and process aspects of the present invention may also be embodied in many other different forms and, thus, should not be limited to such aspects and/or their embodiments which are to be set forth herein. Rather, various exemplary aspects and their embodiments described hereinafter are provided such that this disclosure will be thorough and complete, and fully convey the scope of the present invention to one of ordinary skill in the relevant art.

In one aspect of the present invention, a communication control system may be provided so as to wirelessly control its operations.

In one exemplary embodiment of this aspect of the invention, a system may include at least one control module and at least one target module. Such a control module is arranged to acquire an audio information, a video information, and/or a text information, and to also incorporate therein at least one first transmitter, at least one second transmitter, and at least one input unit. Such a first transmitter is arranged to emit first waves which define first frequencies and carry therealong at least one of such informations and to perform wireless transmission of the first waves to a different control module of a third party directly and/or through a communication provider. The input unit is arranged to acquire at least one command signal which is provided by an user and related to the operations, and the second transmitter is arranged to emit second waves which define second frequencies and carry therealong the command signal and to wirelessly transmit such second waves. The target module is arranged to be disposed away from the control module, to perform such operations not including the transmission, and to include therein at least one receiver which is arranged to receive the second waves and then to extract the command signal from the second waves, whereby the target module performs at least one of the operations only designated by the command signal. Such a target module is to be referred to as the “first target module” hereinafter.

In another exemplary embodiment of this aspect of the invention, such a system may include at least one control module and at least one target module. The control module is arranged to acquire an audio information, a video information, and/or a text information and to also include therein at least one input unit and at least one first transmitter. The input unit is arranged to acquire at least one command signal related to such operations and issued by an user. The first transmitter is arranged to emit first waves defining first frequencies and carrying therealong at least one of the above informations, and to perform wireless transmission of the first waves to a different control module of a third party either directly or through a communication provider in a first occasion or, alternatively, to wirelessly transmit the first waves defining the first frequencies but carrying the command signal therealong in a second occasion. In one example, the target module is disposed away from the control module and arranged to perform the operations other than the transmission and to incorporate therein at least one receiver which is arranged to receive the first waves in the second occasion and to also extract the command signal from the first waves, whereby such a target module is arranged to perform at least one of the operations only designated by the command signal. In another example, the target module is arranged to be disposed away from the control module, to perform the operations other than such transmission, and to include therein at least one receiver and at least one converter, where the receiver is arranged to receive the first waves, while the converter is arranged to operatively couple with the receiver and to convert such first waves into second waves defining second frequencies in the second occasion, whereby the target module is arranged to extract the command signal from the second waves and to perform at least one of the operations only designated by the command signal.

In another exemplary embodiment of this aspect of the invention, such a system may include at least one control module and the above first target module. In one example, such a control module is arranged to acquire an audio information, a video information, and/or a text information, and to include therein at least one first transmitter, at least one second transmitter, at least one first input unit, and at least one second input unit. The first transmitter is generally arranged to emit first waves defining first frequencies and carrying therein at least one of the informations and to perform wireless transmission of the first waves to a different control module of a third party directly thereto or through a provider of communication therebetween or thereto. The first and second input units are arranged to be disposed in different portions of the control module. The first input unit is arranged to receive a first user input provided by an user and required for (or related to) such transmission, while the second input unit is arranged to acquire a second user input carrying therein at least one command signal related to such operations and also provided by the user. The second transmitter is arranged to emit second waves defining second frequencies and carrying therealong the command signal and to wirelessly transmit the second waves. In another example, the control module is arranged to acquire at least one of such informations and to incorporate therein at least one first transmitter, at least one second transmitter, at least one first input unit, and at least one second input unit. Such a first transmitter is arranged to emit first waves defining first frequencies and carrying therealong at least one of the informations and to perform wireless transmission of the first waves to a different control module of a third party directly thereto or through a communication provider. At least a portion of the first input unit is arranged to be at least a portion of the second input unit, where the first input unit is arranged to receive a first user input issued by an user and required for such transmission, while the second input unit is arranged to acquire a second user input provided by the user but including at least one command signal related to the operations. The second transmitter is arranged to emit second waves having second frequencies and carrying therealong the command signal and to wirelessly transmit the second waves. In another example, such a control module is arranged to acquire at least one of the informations, and to include therein at least one first transmitter, at least one second transmitter, and at least one input unit. Such a first transmitter is arranged to emit first waves defining first frequencies and carrying therealong at least one of such informations and to perform wireless transmission of the first waves to a different control module of a third party directly or through a communication provider. The input unit is arranged to acquire at least one first user input provided by an user and required for the transmission in a first occasion and to acquire a second user input issued by the user but including at least one command signal related to the operations in a second occasion. The second transmitter is then arranged to emit second waves defining second frequencies and carrying therealong the command signal and then to wirelessly transmit the second waves.

In another aspect of the present invention, a communication control system may be provided in order to wirelessly communicate with a third party directly or through a communication and in order to wirelessly control its operations.

In one exemplary embodiment of this aspect of the invention, such a system may have at least one control module and at least one target module. The control module is arranged to acquire at least one of an audio information, a video information, and/or a text information, and to have therein at least one first transmitter, at least one second transmitter, and at least one input unit. The first transmitter is arranged to emit microwaves and/or radio waves carrying therealong at least one of the informations and to perform wireless transmission of such microwaves and/or radio waves to the third party. The input unit is arranged to acquire at least one command signal related to the operations and provided by an user. The second transmitter is arranged to emit infrared waves which carry the command signal therealong and to wirelessly transmit such infrared waves. The target module then is arranged to be disposed away from the control module, to perform the operations not including the transmission, and to include therein at least one receiver which is arranged to receive the infrared waves and to extract the command signal from the infrared waves, whereby the target module performs at least one of the operations only designated by the command signal. It is appreciated that such a target module is to be referred to as the “second target module” hereinafter.

In another exemplary embodiment of this aspect of the invention, a system may include at least one control module and the above second target module. The control module is arranged to acquire a text information, n audio information, and/or a video information and to incorporate therein at least one first transmitter, at least one input unit, and at least one converter. The first transmitter is arranged to emit in a first occasion microwaves and/or radio waves which carry therealong at least one of such informations and to perform wireless transmission of the microwaves and/or radio waves to the third party. The input unit is arranged to acquire at least one command signal related to the operations and provided by an user, while the converter is arranged to convert the microwaves and/or radio waves into infrared rays which carry therealong the command signal and to wirelessly transmit the infrared waves.

In another exemplary embodiment of this aspect of the invention, such a system may include at least one control module and at least one target module. The control module is arranged to acquire an audio information, a video information, and/or a text information, and to incorporate therein at least one first transmitter and at least one input unit. The first transmitter is arranged to emit microwaves and/or radio waves carrying therealong at least one of the informations and to perform wireless transmission of the microwaves and/or radio waves to the third party in a first occasion. The input unit is arranged to acquire at least one command signal related to the operations and issued by an user, while the first transmitter is also arranged to emit the microwaves and/or radio waves carrying the command signal therealong and to wirelessly transmit such second waves in a second occasion. It is appreciated that such a control module is to be referred to as the “first control module” hereinafter. The target module is arranged to be disposed away from the control module, to perform the operations not including the transmission, and to include therein at least one receiver and at least one converter. The receiver is arranged to wirelessly receive the first waves in the second occasion, and the converter is arranged to operatively couple with the receiver, to convert such microwaves and/or radio waves into infrared waves, and to extract therefrom the command signal. Therefore, the target module performs at least one of the operations designated by the command signal.

In another exemplary embodiment of this aspect of the invention, such a system may include the above first control module and at least one target module which is arranged to be disposed away from the control module, to perform the operations excluding such transmission, and to include therein at least one receiver and at least one converter. The receiver is arranged to wirelessly receive such first waves in the second occasion, while the converter is arranged to be operatively coupled to the receiver and then to extract the command signal from the microwaves and/or radio waves, whereby the target module performs at least one of the operations only designated by the command signal.

In another aspect of the present invention, a communication control system may include therein at least one control module and at least one target module and which is further capable of wirelessly controlling operations of the target module by the control module. The target module is arranged to be spaced away from the control module and to perform the operations excluding wireless transmission of a video information, an audio information, and/or a text information to a third party directly thereto or through a communication provider based on at least one command signal provided by an user.

In one exemplary embodiment of this aspect of the invention, such a system may have at least one first transmitter, at least one input unit, and at least one second transmitter. The first transmitter is disposed in the control module and arranged to acquire at least one of such informations, to generate first waves defining first frequencies and carrying therein such at least one of the informations, and to perform the transmission of the first waves to the third party. The input unit is incorporated into the control module and arranged to acquire at least one command signal related to the operations and also provided by the user, where this input unit is to be referred to as the “first input unit” hereinafter. The second transmitter is disposed in the control module and arranged to generate second waves having second frequencies and carrying therein the command signal and to wirelessly transmit such second waves to the target module, where such a second transmitter is to be referred to as the “standard second transmitter” hereinafter. Whereby, the target module may be arranged to receive the second waves, to extract therefrom the command signal, and to perform at least one of such operations only designated by the command signal.

In another exemplary embodiment of this aspect of the invention, such a system may have the above first input unit, at least one first transmitter, and at least one converter. Such a first transmitter is disposed in the control module and arranged to acquire at least one of the informations, to generate first waves defining first frequencies and carrying such at least one of such informations therealong, and to perform the transmission of the first waves toward the third party in a first occasion. The first transmitter is further arranged to generate first waves carrying therealong such a command signal in a second occasion. The converter is disposed in the control module and arranged to be operatively coupled to the first transmitter, to convert such first waves into second waves which define second frequencies and carry therein the command signal, and to wirelessly transmit such second waves to the target module in the second occasion. This converter is to be referred to as the “first converter” hereinafter. Whereby such a target module may be arranged to receive the second waves, to extract therefrom the command signal, and to perform at least one of the above operations only designated by the command signal.

In another exemplary embodiment of this aspect of the invention, a system may include such a first input unit and at least one first transmitter which is disposed in the control module and arranged to acquire at least one of the informations, to generate first waves which define first frequencies and carry such at least one of the informations therein, and to perform the transmission of the first waves to the third party in a first occasion, and which is also arranged to generate such first waves carrying therealong the command signal, to convert such first waves into second waves which define second frequencies and carry therealong the command signal, and to wirelessly transmit such second waves to the target module in a second occasion, whereby the target module is arranged to receive the first waves in the second occasion, to extract therefrom the command signal, and to perform at least one of the operations which is only designated by the command signal.

In another aspect of the present invention, a communication control system may include therein at least one household electric device and at least one industrial electric device and which is capable of wirelessly controlling operations of such an electric device with the control module. Such a device is arranged to be disposed away from the control module and to perform the operations based on at least one command signal provided by an user, where the operations exclude wireless transmission of a video information, an audio information, and/or a text information to a third party directly thereto or through a communication provider, while the electric device may be a display device of at least one of such informations, a replay device of the audio information, a storage device of at least one of such informations, a processing device of at least one of such informations, and the like.

In one exemplary embodiment of this aspect of the invention, such a system may have at least one first transmitter, first input unit, and standard second transmitter. The first transmitter is disposed in the control module and arranged to acquire at least one of the informations, to generate first waves having first frequencies and carrying therein such at least one of the informations, and to perform the transmission of the first waves to the third party, whereby the device receives such second waves, extracts therefrom the command signal, and performs at least one of the operations only designated by the command signal.

In another exemplary embodiment of this aspect of the invention, such a system may have the above first input module, at least one first transmitter, and the first converter. Such a first transmitter is disposed in the control module and arranged to acquire at least one of the informations, to generate first waves defining first frequencies and carrying such at least one of the informations therein, and to perform such transmission of the first waves toward the third party in a first occasion. Such a first transmitter is also arranged to generate first waves carrying therein the command signal in a second occasion, whereby the device receives such second waves, extracts therefrom the command signal, and performs at least one of the operations only designated by the command signal.

In another exemplary embodiment of this aspect of the invention, such a system may have the above first input unit and at least one first transmitter which is incorporated in the control module and arranged to acquire at least one of the informations, to generate first waves defining first frequencies and carrying such at least one of the informations therealong, and to perform such transmission of the first waves to the third party in a first occasion. The first transmitter is also arranged to generate first waves carrying therealong the command signal, to convert the first waves into second waves which define second frequencies and carry therealong the command signal, and to wirelessly transmit such second waves to the device in a second occasion, whereby such a device receives the first waves in the second occasion, extracts therefrom such a command signal, and to perform at least one of the operations which is only designated by the command signal.

In another aspect of the present invention, a communication control system may include therein at least one control module and at least one target module and which is also capable of wirelessly controlling operations of the target module with the control module. The control module is arranged to acquire a text information, an audio information, and/or a video information and to also include therein at least one first transmitter which is arranged to emit first waves which define first frequencies and carry therealong at least one of the informations and to also perform wireless transmission of the first waves to a different control module of a third party directly or through a communication provider.

In one exemplary embodiment of this aspect of the invention, a system may include the above first input unit, the standard second transmitter, and at least one receiver which is incorporated in the target module disposed away from the control module while performing the operations excluding such transmission and which is also arranged to receive such second waves and to extract the command signal therefrom, where this receiver is to be referred to as the “first receiver” hereinafter. Whereby the target module performs at least one of the operations only designated by the command signal.

In another exemplary embodiment of this aspect of the invention, such a system may have the above first input unit, the first converter, and the first receiver, where the first transmitter is arranged to generate first waves carrying therealong the command signal as well. Whereby the target module performs at least one of the operations only designated by the command signal.

In another exemplary embodiment of this aspect of the invention, such a system may have the above first input unit, at least one converter, and the first receiver, where the first transmitter is also arranged to generate first waves carrying therealong the command signal. The converter is disposed in the target module and arranged to receive the first waves, to convert such first waves into second waves having second frequencies and carrying therealong such a command signal, and to wirelessly transmit the second waves to the target module. Whereby the target module performs at least one of the operations only designated by the command signal.

In another aspect of the present invention, a communication control system may include therein at least one target module and at least one wireless communication device and which is also capable of wirelessly controlling operations of the target module by the device, where the device is arranged to acquire a text information, an audio information, and/or a video information and to include therein at least one first transmitter which is arranged to emit first waves defining first frequencies and carrying therealong at least one of the informations and to perform wireless transmission of the first waves to a third party directly or through a communication provider. This communication device may be a mobile phone, a cellular phone, a PDA, and a portable wireless communication device capable of performing the transmission.

In one exemplary embodiment of this aspect of the invention, such a system may have at least one input unit, at least one second transmitter, and at least one receiver. The input unit is disposed in the device and arranged to acquire at least one command signal related to the operations and issued by the user, where such an input unit is to be referred to as the “second input unit” hereinafter. The second transmitter is disposed in the device and arranged to generate second waves having second frequencies and carrying therealong the command signal and to also wirelessly transmit such second waves to the target module. The receiver is disposed in the target module disposed away from such a device while performing the operations excluding the transmission and also arranged to receive the second waves and to extract the command signal from the second waves, where such a receiver is to be referred to as the “second receiver” hereinafter. Whereby the target module performs at least one of the operations only designated by the command signal.

In another exemplary embodiment of this aspect of the invention, such a system may have the above second input unit, at least one converter, and the second receiver, where the first transmitter is further arranged to generate first waves carrying therealong the command signal. The converter is disposed in the device and arranged to operatively couple with the first transmitter, to convert the first waves into second waves defining second frequencies and carrying therealong the command signal, and to wirelessly transmit such second waves toward the target module. Whereby the target module performs at least one of the operations only designated by the command signal.

In another exemplary embodiment of this aspect of the invention, such a system may have the above second input unit, at least one converter, and the second receiver, where the first transmitter is further arranged to generate first waves carrying therealong the command signal. The converter is disposed in the target module and arranged to receive the first waves, to convert the first waves into second waves defining second frequencies and carrying therealong the command signal, and then to wirelessly transmit the second waves to the target module. Whereby the target module performs at least one of the operations only designated by the command signal.

In another aspect of the present invention, a communication control system may include therein at least one control module and at least one target module and which is capable of perform wireless control of operations of the target module with the control module, where the control module includes at least one first transmitter which is arranged to acquire an audio information, text information, and/or video information provided by an user, to generate first waves having first frequencies and carrying therealong such at least one of the informations, and to perform such transmission of the first waves to the third party and where the target module is arranged to be spaced away from the control module and to perform the operations not including wireless transmission of at least one of the informations to a third party directly or through a communication provider according to on at least one command signal provided by an user.

In one exemplary embodiment of this aspect of the invention, a system may include at least one at least one first unit, at least one second input unit, and at least one of at least one second transmitter and at least one converter. Each of the first and second input units is disposed in the control module, where the first input unit is arranged to acquire at least one first user input provided by the user and related to the transmission, and the second input unit is arranged to acquire at least one second user input including at least one command signal also provided by the user but related to the control. Such first and second input units are arranged to be spaced away from each other and to be also disposed in different portions of the control module. In one example, the system includes the second transmitter which is incorporated into the control module and also arranged to generate second waves of second frequencies based upon the command signal acquired through the second input unit and to wirelessly transmit the second waves to the target module. In another example, the system instead includes the converter which is also disposed in the control module and arranged to convert such first waves into the second waves defining second frequencies and carrying the command signal therealong, and to wirelessly transmit the second waves to the target module, where this converter is to be referred to as the “second converter” hereinafter. In another example, the system includes the converter which is disposed in the target module and arranged to receive the first waves, where the first transmitter is arranged to generate first waves carrying therealong the command signal in the second occasion and where the converter is further arranged to extract the command signal from the first waves. Such a converter is to be referred to as the “third converter” hereinafter. Whereby, such a target module is arranged to receive the second waves, to extract the command signal therefrom, and to also perform at least one of the operations which is only designated by the command signal.

In another exemplary embodiment of this aspect of the invention, a system may include at least one input unit and at least one of at least one second transmitter and at least one converter. The input unit is arranged to be incorporated in the control module and to include multiple keys each of which is assigned with one label and at least one of which is further arranged to be assigned with at least two different labels and to operate as a common key. The common key is arranged to be assigned with a first label and to acquire in a first occasion a first user input provided by the user and related to such transmission, to be also assigned with a second label, and to acquire in a second occasion a second user input carrying at least one command signal, also provided by the user, but related to the control. In one example, the system includes the second transmitter which is disposed in the control module and arranged to generate second waves defining second frequencies based on the command signal acquired through the input unit and to wirelessly transmit the second waves to the target module. In another example, the system includes the second converter. In another example, the system includes the third converter. Whereby the target module is arranged to receive the second waves, to extract therefrom the command signal, and to perform at least one of the operations only designated by the command signal in each of the above examples.

In another exemplary embodiment of this aspect of the invention, such a system may include at least one input unit and at least one of at least one second transmitter and at least one converter. The input unit is arranged to be incorporated in the control module and to include at least one touch screen defining a first set and a second set each also forming multiple portions thereon, where the first set of the portions is arranged to acquire at least one first user input provided by the user and related to the transmission, whereas the second set of the portions is arranged to acquire at least one second user input including at least one command signal also issued by the user but related to the control. The first and second sets are further arranged to be defined in different portions of the control module. In one example, the system includes the second transmitter which is incorporated in the control module and arranged to generate second waves of second frequencies based on the command signal acquired through the second set and to wirelessly transmit the second waves to the target module. In another example, the system includes the second converter. In another example, the system includes the third converter. Whereby, the target module may be arranged to receive the second waves, to extract the command signal therefrom, and to perform at least one of the operations which is only designated by the command signal in each of the examples.

In another exemplary embodiment of this aspect of the invention, such a system may include at least one input unit and at least one of at least one second transmitter and at least one converter. The input unit is arranged to be incorporated in the control module and to include at least one touch screen defining multiple portions each of assigned with one label and at least one of which is arranged to be assigned with at least two different labels and to operate as a common portions. The common portion is arranged to be assigned with a first label and to acquire in a first occasion a first user input issued by the user and related to such transmission. The common portion is further arranged to be assigned with a second label and to acquire in a second occasion a second user input carrying therein at least one command signal, also provided by the user, but related to the control. In one example, the system includes the second transmitter is incorporated in the control module and arranged to generate second waves of second frequencies based upon the command signal acquired through the input unit and to wirelessly transmit the second waves to the target module. In another example, the system includes the second converter. In another example, the system includes the third converter. Whereby, such a target module is arranged to receive the second waves, to extract therefrom the command signal, and to perform at least one of the operations only designated by the command signal in each of the above examples.

In another exemplary embodiment of this aspect of the invention, such a system may include at least one input unit and at least one of at least one second transmitter and at least one converter. The input unit is arranged to be incorporated in the control module and to also include at least one display displaying a first set and a second set each including multiple icons therein. The first set of the icons is arranged to be selected by at least one first user input which is provided by the user and related to the transmission, while the second set of the icons is similarly arranged to be selected by at least one second user input including at least one command signal also provided by the user but related to the control. The first and second sets are also arranged to be defined in different portions of the control module. In one example, the system includes the second transmitter which is disposed in the control module and arranged to generate second waves defining second frequencies based on the command signal acquired through the second set and to wirelessly transmit the second waves to such a target module. In another example, the system includes the second converter. In another example, such a system includes the third converter. Whereby, the target module is arranged to receive such second waves, to extract therefrom the command signal, and to perform at least one of such operations only designated by the command signal in each of such examples.

In another exemplary embodiment of this aspect of the invention, such a system may include at least one input unit and at least one of at least one second transmitter and at least one converter. The input unit is arranged to be disposed in the control module and to include at least one display showing multiple icons each of which is assigned with one label and at least one of which is also arranged to be assigned with at least two different labels so as to operate as a common icon. The common icon is also arranged to be assigned with a first label and to be selected in a first occasion by a first user input provided by the user and related to such transmission. The common icon is also arranged to be assigned with a second label and to be further selected in a second occasion by a second user input carrying therealong at least one command signal, provided by the user, but related to such control. In one example, the system includes the second transmitter which is incorporated in the control module and arranged to generate second waves defining second frequencies based on the command signal acquired through the input unit and to wirelessly transmit the second waves to the target module. In another example, the system includes the second converter. In another example, the system includes the third converter. Whereby the target module is arranged to receive such second waves, to extract therefrom the command signal, and to perform at least one of such operations only designated by the command signal in each of such examples.

Embodiments of such apparatus aspects of the present invention may include one or more of the following features, while configurational and/or operational variations and/or modifications of the foregoing systems also fall within the scope of the present invention.

Such video information may include a still picture, a dynamic video clip, and the like. The video information may be the picture and/or video clip which may be acquired in real time, may be prestored in the system, and/or may be acquired from an external source. The audio information may include a voice of the user, a voice of the third party, a music, and/or a sound related with musical or industrial instruments. The audio information may be the voice, music, and/or sound which may be acquired in real time, may be prestored in the system, may be acquired from an external source, and the like. The text information may include a single or multiple alphabets, numerals, symbols, mathematical operators, and the like. The text information may be related to the audio and/or video informations such as lyrics of the songs, captions of movies, and the like. Such a provider may be a wireless telecommunication provider, an internet provider, a wireless audiovisual broadcaster, and the like.

The first frequencies may be in those ranges of radio waves and/or microwaves, while such second frequencies may be in the ranges of the first frequencies or infrared waves. Such first and second frequencies may differ from each other and, therefore, the first and second transmitters may be separate transmitters. Such first and second frequencies may be identical or at least substantially similar to each other and, accordingly, such first and second transmitters may be a single transmitter. Both of the first and second generators may transmit only radio waves and/or microwaves or, in the alternative, may transmit only infrared waves. The first and second transmitters may also be a single transmitter emitting only one of the waves of the first and second frequencies, and the target module may control its operations based upon such only one of the waves or, alternatively, the target module may convert the one of the waves into another of such waves and control its operations based upon the another of the waves. The first and second transmitters may be disposed in the same portion of the control module. The first transmitter may be a conventional transmitter of the radio waves and/or microwaves, while the second transmitter may be a light emitting diode capable of emitting the infrared waves. The first and second transmitters may be disposed in different portions of the control module. The control module may perform not only the transmission but also reception of third waves which are transmitted by the different control module of the third party.

The input unit may include multiple keys so that the user may apply the user input to the control module by providing mechanical force and/or contact to the keys. The keys may be provided with the labels which may explain specific features of the control and/or transmission. The input unit may also include at least one touch screen such that the user may apply the user input to the control module by providing mechanical force and/or contact to various portions thereof. Such portions may be provided with the labels which may explain the features of the control and/or transmission. The input unit may include at least one display and the user may apply the user input to the control module by selecting an icon displayed on the display. The icons may be provided with the labels which may describe the features of the control and/or transmission and/or control. The input unit may include at least one of the common key, portion, and/or icon. The first input unit may be one of the keys, screen, and display, whereas the second input unit may be another of the keys, screen, and display. Both of the first and second input units may be one of such keys, screen, and display, where the user may apply the first and second user inputs by manipulating different portions of the one of the keys, screen, and display or, alternatively, the user may apply the first and second user inputs by manipulating identical portions of the one of the keys, screen, and display. The first and second units may also include at least one common key which may be assigned with different labels one of which may be designated for such transmission and recruited for acquiring the first user input and another of which may be designated for such control and utilized for acquiring the second user input. The user may provide the first and second user inputs in the first and second occasions by applying forces to the keys or touch screen, contacting the keys or touch screen, selecting one or multiple icons displayed on the display, and the like. The user may also provide the first and second user inputs in the first and second occasions by applying mechanical forces to the same key or different keys, applying the forces to the same portion or different portions of the touch screen, contacting the identical key or different keys, contacting the same portion or different portions of the screen or selecting the identical or different icons displayed on the display. The user may represent each of such first and second occasions by transmitting the waves of the different frequencies. The user may represent each of the first and second occasions by manipulating the control module or, in the alternative, by pointing the control module away from or toward the target module.

The converter may be disposed in the control module, exposed through the control module or, in the alternative, may be retrofit over the control module. The control and target modules may not be coupled to each other by electrical and/or optical wire. The target module may perform the operations independently of and/or separately from the control module except through the second waves which are transmitted by the control module. The target module may control the operations strictly based on the command signal or, alternatively, based upon a secondary signal derived from the command signal by the target module. Such operations may include turning on and/or off the target module, controlling amplitudes or audible properties of sounds generated by the target module, selecting and/or changing a source of the sounds, controlling visual properties of images displayed by or on the target module, selecting and/or changing a source of the images, and the like.

In another aspect of the present invention, a method may be provided for performing wireless control of operations of a target module of a communication control system by a control module of the system which is spaced away from the target module and which is capable of generating first waves in first frequencies and performing wireless transmission of such first waves carrying therealong an audio information, a text information, and/or a video information to a third party directly and/or through a provider of communication.

In one exemplary embodiment of this aspect of the invention, a method may have the steps of: acquiring from an user at least one command signal which is related to such control (to be referred to as the “first acquiring” hereinafter); generating second waves in second frequencies different from such first frequencies by the control module while carrying the command signal therealong; and then wirelessly transmitting the second waves toward the target module, thereby performing the control of the operations of the target module based upon such a command signal (to be referred to as the “first transmitting” hereinafter).

In another exemplary embodiment of this aspect of the invention, a method may have the steps of: the first acquiring; carrying such a command signal along the first waves (to be referred to as the “first carrying” hereinafter); and then wirelessly transmitting the first waves, thereby performing such control of the operations of the target module based on the command signal.

In another exemplary embodiment of this aspect of the invention, a method may have the steps of: the first acquiring; the first carrying; converting such first waves into second waves which define different frequencies; and the first transmitting. The above first carrying and converting may also be replaced by the steps of: converting the first waves into second waves of different frequencies; and carrying along the second waves the command signal.

In another exemplary embodiment of this aspect of the invention, a method may have the steps of: the first acquiring; the first carrying; wirelessly transmitting such first waves; and then converting the first waves to second waves of different frequencies in the target module to extract the command signal from the second waves, thereby performing the control of the operations of the target module.

In another aspect of the present invention, a method may be provided for performing wireless control of operations of a target module of a communication control system by a control module of the system which is physically spaced away from the target module and which is capable of performing wireless transmission of an audio information, a text information, and/or a video information to a third party directly and/or through a communication provider.

In one exemplary embodiment of this aspect of the invention, a method may have the steps of: generating first waves in preset frequencies by such a control module (to be referred to as the “first generating” hereinafter); carrying at least one of the above informations in a first occasion along such first waves (to be referred to as the “second carrying” hereinafter); wirelessly transmitting such first waves, thereby performing the transmission of the at least one of the informations to the third party in the first occasion (which will be referred to as the “second transmitting” hereinafter); acquiring from an user at least one command signal for the control in a second occasion; generating second waves in second frequencies different from the first frequencies by the control module while carrying such a command signal therealong; and wirelessly transmitting the second waves toward the target module, thereby performing the control of the operations based on the command signal in the second occasion (to be referred to as the “third transmitting” hereinafter).

In another exemplary embodiment of this aspect of the invention, a method may have the steps of: acquiring from an user a first user input related to the communication in a first occasion (which will be referred to as the “second acquiring” hereinafter); acquiring a second user input which includes a command signal related to such control from the user in a second occasion (which will be referred to as the “third acquiring” hereinafter); the first generating; the second carrying; carrying along the first waves the command signal in the second occasion; and then wirelessly transmitting the first waves, thereby performing at least one of the transmission in the first occasion and the control in the second occasion (to be referred to as the “fourth transmitting” hereinafter).

In another exemplary embodiment of this aspect of the invention, a method may have the steps of: the first generating; the second acquiring; carrying at least one of such informations along the first waves in the first occasion; the third acquiring; carrying along the first waves the command signal in the second occasion; converting frequencies of the first waves to generate second waves; and the third transmitting. The above carrying and converting may also be replaced by the following steps of: converting frequencies of the first waves to generate second waves; and carrying along the second waves the command signal in the second occasion.

In another exemplary embodiment of this aspect of the invention, a method may have the steps of: the second acquiring; the third acquiring; the first generating; the second carrying; carrying along such first waves the command signal in the second occasion; the fourth transmitting; and converting the first waves to second waves of different frequencies in the target module to extract the command signal from the second waves thereafter, thereby performing such control of the operations of such a target module in the second occasion (to be referred to as the “first converting” hereinafter).

In another aspect of the present invention, a method may be provided for performing wireless control of operations of a target module of a communication control system by a control module of the system based on at least one command signal provided thereto by an user, where the control module is spaced away from the target module and capable of performing wireless transmission of an audio information, a text information, and/or a video information to a third party one of directly and through a provider of communication.

In one exemplary embodiment of this aspect of the invention, a method may have the steps of: generating first waves in frequency of microwaves (or radio waves) with the control module (which will be referred to as the “second generating” hereinafter); carrying at least one of such informations along the first waves for the above transmission (to be referred to as the “third carrying” hereinafter); wirelessly transmitting the first waves, thereby performing the transmission (to be referred to as the “fifth transmitting” hereinafter); generating second waves in frequency of infrared waves by such a control module; carrying the command signal along the second waves for the control of the operations of the target module (to be referred to as the “fourth carrying” hereinafter); and the first transmitting.

In another exemplary embodiment of this aspect of the invention, a method may have the steps of: the second generating; the third carrying; the fifth transmitting; carrying the command signal along the first waves for such control of the operations of the target module (to be referred to as the “fifth carrying” hereinafter); converting the first waves to second waves in frequencies of infrared waves; and wirelessly transmitting the second waves to the target module, thereby performing such control based on the command signal. The above carrying and converting may be replaced by the steps of: converting the first waves into second waves in frequencies of infrared waves; and then the fourth carrying.

In another exemplary embodiment of this aspect of the invention, such a method may have the steps of: the second generating; the third carrying; the fifth transmitting; the fifth carrying; wirelessly transmitting the first waves; and the first converting.

In another exemplary embodiment of this aspect of the invention, such a method may have the steps of: the second generating; the third carrying; the fifth transmitting; the fifth carrying; wirelessly transmitting the first waves; and extracting thereafter the command signal from the first waves in the target module, thereby performing the control of the operations of the target module.

In another aspect of the present invention, a method may be provided for performing wireless control of operations of at least one of a household electric device and an industrial electric device by a control module of a communication control system based upon at least one command signal provided thereto by an user, where the control module is disposed away from such a device and which is also capable of performing wireless transmission of an audio information, a text information, and/or a video information to a third party directly and/or through a communication provider, where the device is also configured to perform such operations based upon at least one command signal provided by an user, where the operations exclude the transmission, and where the device is a display device of at least one of such informations, a replay device of the audio information, a storage device of at least one of the informations, and/or a processing device of the informations.

In one exemplary embodiment of this aspect of the invention, a method may have the steps of: the first generating; the second carrying; the second transmitting; providing the control module with at least one additional means capable of generating second waves in second frequencies different from those of the first waves while carrying such a command signal therealong; and thereafter wirelessly transmitting the second waves to the device, thereby performing the control of the operations based on the command signal in the second occasion (which is to be referred to as the “sixth transmitting” hereinafter).

In another exemplary embodiment of this aspect of the invention, a method may have the steps of: the first generating; the second carrying; the third acquiring; the first carrying; and then the fourth transmitting.

In another exemplary embodiment of this aspect of the invention, a method may have the steps of: the first generating; the second carrying; the third acquiring; carrying the command signal along the first waves in the second occasion; converting frequencies of such first waves to generate second waves; and the sixth transmitting. The above carrying and converting may be replaced by the steps of: converting frequencies of the first waves to generate second waves; and carrying the command signal along the second waves in the second occasion.

In another aspect of the present invention, a method may be provided for performing wireless control of operations of a target module of a communication control system by at least one wireless communication device of such a system based upon at least one command signal provided thereto by an user, where the device is disposed away from the target module, includes therein at least one first transmitter emitting first waves defining first frequencies, and performs wireless transmission of an audio information, a text information, and/or a video information carried along with the first waves and transmitted by the transmitter to a third party directly and/or through a provider of communication, and where the device is a mobile phone, a cellular phone, a PDA, and a portable wireless communication device which is capable of performing the transmission, and the like.

In one exemplary embodiment of this aspect of the invention, a method may have the steps of: generating first waves in preset frequencies by the communication device; the second carrying; the second transmitting; providing the communication device with at least one additional means capable of generating second waves in second frequencies which are different from those of such first waves while carrying therein the command signal; and the third transmitting.

In another exemplary embodiment of this aspect of the invention, a method may have the steps of: generating first waves in preset frequencies by the communication device; the second carrying; the third acquiring; the first carrying; and the fourth transmitting.

In another exemplary embodiment of this aspect of the invention, such a method may have the steps of: generating first waves which define preset frequencies by the communication device; the second carrying; the third acquiring; carrying the command signal along the first waves in the second occasion; converting frequencies of such first waves to generate second waves; and then the sixth transmitting. Such carrying and converting may be replaced by the steps of: converting frequencies of the first waves to generate second waves; and carrying along such second waves the command signal in the second occasion.

Embodiments of such method aspects of the present invention may include one or more of the following features, and configurational and/or operational variations and/or modifications of the above processes also fall within the scope of the present invention.

The generating the first waves may include one of the steps of: generating the first waves in frequencies of radio waves; generating the first waves in frequencies of microwaves, and the like. The generating the second waves may include one of the steps of: generating the second waves in frequencies of at least one of radio waves and microwaves; generating the waves in frequencies of infrared waves, and the like. The generating the second waves may also include one of the steps of: generating the first and second waves with the control module simultaneously; generating the second waves without generating the first waves by the control module, and the like. The generating the first and/or second waves may include one of the steps of: generating the first and second waves by a single wave generator; and generating such first and second waves by different wave generators. The generating the first and second waves may also include one of the steps of: modulating the first waves in frequencies of radio waves and/or microwaves while modulating such second waves in frequencies of infrared waves; modulating the first and second waves in frequencies of such radio waves and/or microwaves, and the like.

Such acquiring may include at least one of the steps of: receiving mechanical force applied by the user; receiving mechanical contact formed by the user; assessing one of the keys selected by the user; assessing one of the icons selected by the user, and the like. The acquiring may include at least one of the steps of: receiving such audio information while extracting the command signal therefrom; receiving movement of the control module while extracting the command signal therefrom; assessing movement and/or position of a body part of the user while extracting the command signal therefrom; assessing movement and/or position of the control module while extracting therefrom the command signal, and the like.

The carrying may include one of the steps of: modulating amplitudes of the waves based upon the first user input, second user input, and/or command signal; modulating frequencies of the waves based upon the first user input, second user input, and/or command signal, and the like. The carrying may include the step of: superposing onto the waves at least one of the first user input, second user input, and command signal.

The transmitting the first waves may have one of the steps of: propagating the first waves in frequencies of radio waves; propagating the first waves in frequencies of microwaves, and the like. The transmitting the second waves may include one of the steps of: propagating the second waves in frequencies of at least one of radio waves and microwaves; propagating the waves in frequencies of infrared waves, and the like. The transmitting the second waves may include one of the steps of: propagating both of the first and second waves with the control module simultaneously; propagating the second waves without propagating the first waves by such a control module, and the like. Such transmitting the second waves may include the steps of: acquiring such a command signal; pointing a preset portion of the control module toward the target module; and transmitting the first and/or second waves toward the target module. The performing the transmission may include the step of: receiving from the third party (or provider) at least one of the informations.

In another aspect of the present invention, a communication control system may be provided to incorporate thereinto at least one control module and at least one target module and to be also capable of wireless control of at least one of operations of the target module with the control module, where the control module is also capable of acquiring an audio information, a video information, and/or a text information, to generate first waves which define first frequencies and carry therealong at least one of the informations, and to perform wireless transmission of the first waves which carry at least one of the informations to a third party directly or through a communication provider, and where the target module is also spaced away from the control module and to perform the operations which excludes the transmission.

In one exemplary embodiment of this aspect of the invention, a system may be fabricated by a process which includes the steps of: acquiring at least one command signal issued by an user of the system and related to such control with the control module; generating by the control module second waves which define second frequencies and also carry the command signal therealong; wirelessly transmitting the second waves toward the target module by the control module; receiving the second waves with the target module; and extracting the command signal from the second waves, whereby controlling at least one of the operations of the target module based upon the command signal (to be referred to as the “first extracting” hereinafter).

In another exemplary embodiment of this aspect of the invention, a system may be made by a process which includes the steps of: performing such wireless transmission of the first waves in a first occasion (to be referred to as the “first performing” hereinafter); acquiring at least one command signal provided by an user of the system and related to such control in a second occasion (which will be referred to as the “first acquiring” hereinafter); carrying the command signal along the first waves in the second occasion (to be referred to as the “first carrying” hereinafter); wirelessly transmitting the first waves to such a target module in the second occasion (which will be referred to as the “first transmitting” hereinafter); receiving the first waves by the target module (to be referred to as the “first receiving” hereinafter); and extracting the command signal from the first waves, whereby controlling at least one of the operations of the target module based upon the command signal.

In another exemplary embodiment of this aspect of the invention, such a system may be made by a process including the steps of: the first performing; the first acquiring; the first carrying; the first transmitting; the first receiving; converting the first waves into second waves which define different frequencies and still carrying therealong the command signal (to be referred to as the first converting” hereinafter); and the first extracting.

In another exemplary embodiment of this aspect of the invention, such a system may be made by a process including the steps of: providing the control module with at least one first transmitter, at least one second transmitter, and at least one input unit (which will be referred to hereinafter as the “first providing”); providing the target module with at least one receiver (which will be referred to as the “second providing” hereinafter); performing the wireless transmission of the first waves with the first transmitter (which will be referred to as the “second performing” hereinafter); acquiring at least one command signal provided by an user of the system and related to the operations with the input unit (to be referred to as the “second acquiring” hereinafter); generating by such a second transmitter second waves having second frequencies and carrying the command signal therealong; wirelessly transmitting the second waves to the target module with the second transmitter (to be referred to as the “second transmitting” hereinafter); receiving the second waves with the receiver (to be referred to as the “second receiving” hereinafter); and the first extracting.

In another exemplary embodiment of this aspect of the invention, such a system may be made by a process including the steps of: providing such a control module with at least one first transmitter and at least one input unit (to be referred to as the “third providing” hereinafter); the second providing; performing the wireless transmission of the first waves with the first transmitter in a first occasion (to be referred to as the “third performing” hereinafter); acquiring at least one command signal provided by an user of such a system and related to the operations with the input unit in a second occasion (to be referred to as the “third acquiring” hereinafter); the first carrying; wirelessly transmitting the first waves to the target module with the first transmitter in the second occasion (to be referred to as the “third transmitting” hereinafter); receiving the first waves with the receiver (to be referred to as the “third receiving” hereinafter); and then extracting the command signal from the first waves, whereby controlling at least one of the operations of the target module based upon the command signal.

In another exemplary embodiment of this aspect of the invention, a system may be made by a process which includes the steps of: the third providing; providing the target module with at least one receiver and at least one converter; the third performing; the third acquiring; the first carrying; the third transmitting; the third receiving; converting the first waves into second waves which define different frequencies and still carrying therealong the command signal; and the first extracting.

In another aspect of the present invention, a communication control system may be provided to incorporate thereinto at least one control module and at least one target module and to be also capable of wireless control of at least one of operations of the target module with the control module, where the control module is also capable of acquiring an audio information, a video information, and/or a text information, to generate first waves which define first frequencies in ranges of radio waves and/or microwaves and carrying therealong at least one of the informations, and to further perform wireless transmission of the first waves carrying at least one of the informations to a third party directly and/or through a provider of communication, and where the target module is disposed away from the control module and to perform the operations excluding the transmission.

In one exemplary embodiment of this aspect of the invention, a system may be fabricated by a process including the steps of: the first providing; the second providing; the second performing; the second acquiring; generating by the second transmitter second waves having second frequencies in ranges of infrared rays and carrying such a command signal therealong; the second transmitting; the second receiving; and the first extracting.

In another exemplary embodiment of this aspect of the invention, a system may be made by a process including the steps of: the third providing; the second providing; the third performing; the third acquiring; the first carrying; the third transmitting; the third receiving; and then extracting the command signal from the first waves, whereby controlling at least one of the operations of such a target module based upon the command signal.

In another exemplary embodiment of this aspect of the invention, a system may be made by a process which includes the steps of: the third providing; providing the target module with at least one receiver and at least one converter; the third performing; the third acquiring; the first carrying; the third transmitting; the third receiving; converting the first waves to second waves defining frequencies in ranges of infrared waves and still carrying therealong the command signal; and the first extracting.

In another aspect of the present invention, a communication control system may be provided to incorporate thereinto at least one control module and at least one target module and to be also capable of wireless control of at least one of multiple operations of the target module with the control module, where such a control module is arranged to be spaced away from the target module, to generate first waves defining first frequencies, and to perform wireless transmission of such first waves carrying therealong an audio information, a video information, and/or a text information to a third party directly and/or through a communication provider.

In one exemplary embodiment of this aspect of the invention, a system may be fabricated by a process including the steps of: arranging the control module to acquire at least one command signal related to the control; generating second waves in second frequencies which are different from the first frequencies by the control module while carrying the command signal therealong (to be referred to as the “first arranging” hereinafter); and then wirelessly transmitting the second waves toward the target module, thereby performing such control of the operations of the target module based upon the command signal (to be referred to as the “fourth transmitting” hereinafter).

In another exemplary embodiment of this aspect of the invention, a system may be made by a process including the steps of: the first arranging; carrying along the first waves the command signal (to be referred to as the “second carrying” hereinafter); and wirelessly transmitting the first waves, thereby performing the control of the operations of the target module based on the command signal.

In another exemplary embodiment of this aspect of the invention, a system may be made by a process including the steps of: the first arranging; the second carrying; converting such first waves into second different waves with the control module; and the fourth transmitting. The above second carrying and converting may be replaced by the steps of: converting such first waves into second different waves by the control module; and carrying along the second waves the command signal.

In another exemplary embodiment of this aspect of the invention, a system may be made by a process which includes the steps of: the first arranging; the second carrying; wirelessly transmitting the first waves; converting such first waves into second different waves by the target module; and then extracting such a command signal from the second waves, thereby performing the control of the operations of the target module.

In another aspect of the present invention, a communication control system may be provided to incorporate thereinto at least one control module and at least one target module and to be also capable of wireless control of at least one of multiple operations of the target module with the control module which is physically disposed away from the target module and which is further capable of performing wireless transmission of an audio information, a text information, and/or a video information to a third party directly and/or through a communication provider.

In one exemplary embodiment of this aspect of the invention, a system may be fabricated by a process including the steps of: generating first waves in preset frequencies by the control module (to be referred to as the “first generating” hereinafter); carrying at least one of the informations into such first waves by the control module in a first occasion (which will be referred to as the “third carrying” hereinafter); wirelessly transmitting the first waves, thereby performing such transmission of such at least one of the informations to the third party in the first occasion; acquiring with the control module a command signal for the control in a second occasion; generating second waves which have second frequencies different from such first frequencies by the control module while carrying the command signal therealong; and wirelessly transmitting the second waves toward the target module, thereby performing the control of the operations based on the command signal in the second occasion (to be referred to as the “fifth transmitting” hereinafter).

In another exemplary embodiment of this aspect of the invention, a system may be made by a process including the steps of: arranging the control module to acquire a first user input related to the transmission in a first occasion (to be referred to as the “second arranging” hereinafter); arranging the control module to acquire a second user input incorporating therein at least one command signal related to the control in a second occasion (to be referred to as the “third arranging” hereinafter); the first generating; the third carrying; carrying the command signal into the first waves by such a control module in the second occasion; and then wirelessly transmitting the first waves, thereby performing the transmission in the first occasion and the control in the second occasion (to be referred to as the “sixth transmitting” hereinafter).

In another exemplary embodiment of this aspect of the invention, a system may be made by a process including the steps of: the first generating; the second arranging; the third carrying; the third arranging; carrying the command signal also into the first waves by the control module in the second occasion; converting the first waves to generate second, different waves by the control module; and the fifth transmitting. The above carrying and converting may be replaced by the steps of: converting the first waves for generating second, different waves by the control module; and then carrying such a command signal into the second waves by the control module in the second occasion.

In another exemplary embodiment of this aspect of the invention, a system may be made by a process including the steps of: the second arranging; the third arranging; the first generating; the third carrying; carrying the command signal also into such first waves by the control module in the second occasion; the sixth transmitting; and the first converting.

In another aspect of the present invention, a communication control system may be provided to incorporate thereinto at least one control module and at least one target module and to be also capable of performing wireless control of operations of the target module with the control module, where such a control module includes at least one first transmitter and is arranged to acquire a text information, an audio information, and/or a video information provided by an user, to generate first waves having first frequencies and carrying therealong at least one of the informations, and to perform transmission of the first waves toward the third party by the first transmitter and where the target module is arranged to be spaced away from the control module and to perform the operations excluding the transmission of at least one of the informations to a third party directly and via a communication provider based on at least one command signal provided by an user.

In one exemplary embodiment of this aspect of the invention, a system may be fabricated by a process including the steps of: providing the control module with at least one first input unit as well as at least one second input unit in different portions thereof; arranging such a first input unit to acquire a first user input which is related to the transmission; and arranging the second input unit to acquire the command signal which is related to such control. In one example, the process also includes the steps of: providing the control module with at least one second transmitter; the second providing; generating second waves having second frequencies and carrying therealong the command signal by the control module unit; the second transmitting; and the second receiving. In another example, the process also includes the steps of: providing at least one receiver and at least one converter to the control module; carrying the command signal in the first waves by the control module; wirelessly transmitting the first waves to the target module by the second transmitter; the third receiving; and then converting the first waves to second waves defining second frequencies and carrying therealong the command signal. In each example, the process further includes the step of: the first extracting.

In another exemplary embodiment of this aspect of the invention, a system may be made by a process including the steps of: providing the control module with at least one first input unit as well as at least one second input unit in different portions thereof; arranging such a first input unit to acquire a first user input related to the transmission; arranging the second input unit to acquire such a command signal which is related to the control; carrying the command signal into such first waves by the control module; the second providing; wirelessly transmitting the first waves to the target module by the first transmitter; the third receiving; and then extracting the command signal from the first waves, whereby controlling at least one of the operations of the target module based upon the command signal.

In another aspect of the present invention, a communication control system may be provided to incorporate thereinto at least one control module and at least one target module and to be also capable of performing wireless control of at least one of multiple operations of the target module by the control module, where the control module is arranged to acquire a text information, audio information, and/or video information provided by an user of the system, to generate first waves having first frequencies and carrying therein at least one of the informations, and to also perform wireless transmission of the first waves carrying therealong at least one of the informations to the third party and where the target module is arranged to be disposed away from the control module and to perform such operations not including the transmission to a third party directly and/or through a communication provider based on at least one command signal provided by the user.

In one exemplary embodiment of this aspect of the invention, a system may be fabricated by a process including the steps of: providing the control module with multiple keys (which will be referred to as the “fourth providing” hereinafter); assigning each of the keys with a different label; acquiring a first user input related to the transmission with one set of the keys; performing such transmission by the control module in response to such a first user input (to be referred to as the “fourth performing” hereinafter); acquiring the command signal related to such control using a different set of such keys; carrying the command signal into the first waves and/or alternative waves of different frequencies by the control module (to be referred to as the “fourth carrying” hereinafter); and transmitting such one of the waves to the target module, thereby performing the control of such at least one of the operations of the target module (to be referred to as the “seventh transmitting” hereinafter).

In another exemplary embodiment of this aspect of the invention, a system may be made by a process including the steps of: the fourth providing; assigning each of the keys with at least one label while selecting at least one of such keys as a common key assigned with at least two different labels one of which is for the transmission while another of which is for such control; acquiring a first user input related to the transmission with the common key as designated by one of such labels; the fourth performing; acquiring the command signal related to the control with the common key as designated by the other of the labels; the fourth carrying; and the seventh transmitting.

In another exemplary embodiment of this aspect of the invention, a system may be made by a process including the steps of: providing the control module with at least one touch screen defining multiple portions (to be referred to as the “fifth providing” hereinafter); assigning each of the portions with a different label; acquiring a first user input which is related to such transmission with one set of the portions; the fourth performing; acquiring the command signal related to the control with a different set of the portions; the fourth carrying; and the seventh transmitting.

In another exemplary embodiment of this aspect of the invention, a system may be made by a process including the steps of: the fifth providing; assigning each of the keys with at least one label while selecting at least one of the keys as a common key assigned with at least two different labels one of which is for the transmission while another of which is for the control; acquiring a first user input related to the transmission with the common key as designated by one of the labels; the fourth performing; acquiring the command signal related to the control with the common key as designated by the other of the labels; the fourth carrying; and the seventh transmitting.

In another exemplary embodiment of this aspect of the invention, a system may be made by a process including the steps of: providing the control module with at least one display defining multiple objects (to be referred to as the “sixth providing” hereinafter); assigning each of such objects with a different label; acquiring a first user input related to such transmission with one set of the objects; the fourth performing; acquiring the command signal which is related to the control with a different set of the objects; the fourth carrying; and the seventh transmitting.

In another exemplary embodiment of this aspect of the invention, a system may be made by a process which includes the steps of: the sixth providing; assigning each of such objects with at least one label while selecting at least one of such objects as a common object assigned with at least two different labels one of which is designated for the transmission while another of which is designated for the control; acquiring a first user input which is related to the transmission with the common object as designated by one of the labels; the fourth performing; acquiring the command signal related to the control with the common object as designated by the other of the labels; the fourth carrying; and the seventh transmitting.

More product-by-process claims may be constructed by modifying the foregoing preambles of the apparatus (or system) claims and/or method claims and by appending thereto such bodies of the apparatus (or system) claims and/or method claims. In addition, such process claims may include one or more of such features of the apparatus (or system) claims and/or method claims of this invention.

The communication control systems of this invention may be provided in various embodiments. For example, the control systems may employ various prior art communication devices as their control modules, and may modify their transmitters and/or include therein extra transmitters for emitting such electromagnetic waves which may be received and recognized by various remotely controllable prior art electric devices, thereby controlling the operations of such electric devices by the control modules. In another example, the control systems may incorporate various prior art controllable devices as their target modules, and may then modify their receivers and/or incorporate thereinto extra receivers for receiving and recognizing the electromagnetic waves emitted by the communication devices, thereby controlling the operations of the target modules by the communication devices.

In general, such control modules may be provided by utilizing and/or modifying various prior art communication devices or, preferably, various prior art wireless communication devices examples of which may include, but not be limited to, mobile or cellular wireless phones, PDA's, walkie-talkies, and other wireless information transmission (and optional reception) devices, where such an information may include, but not be limited to, audio (or audible) information, still picture information, dynamic video information, text information, and the like. The control modules may also be provided by utilizing and/or modifying portable portions (e.g., handsets) of various conventional wired communication devices, by employing and/or modifying portable portions (e.g., headsets or earsets) of the conventional wireless communication devices, and the like. As long as a wireless or wired communication device and/or its modification may allow an user to communicate any of such informations with a third party (or simply transmit any of such informations) either directly or through various communication providers including internet providers, this device may qualify as the control module within the scope of this invention and may be employed to control various operations of the target modules. It is to be understood that such control modules within the scope of this invention may be any of the above devices in which wireless communication may be its primary function or, in the alternative, such wireless communication may be its secondary or ancillary function.

The target modules may generally be provided by employing and/or modifying various remotely controllable prior art electric devices, where examples of these remotely controllable electric devices may include, but not be limited to, storage devices of any of the above informations (e.g., devices with magnetic and/or optical storage disks, devices with semiconductor storage chips, devices capable of storing any of such informations in any of such disks and/or chips, and so on), display and/or playing devices of any of such informations (e.g., magnetic disk drivers, optical disk drivers, microprocessors capable of driving any of such disks and/or storage chips, devices capable of retrieving any of such informations from any of such storage devices without necessarily processing and/or modifying any of such informations), processing devices of any of such informations (e.g., laptop computer, PDA's, personal information or data organizers, information processing devices capable of sorting, selecting, rearranging, editing, modifying, and/or otherwise processing any of such informations stored therein and/or retrieved from various sources external thereto), security devices (e.g., surveillance cameras, monitors, actuators, doors, locks, alarms, and the like), personal or public transportation devices (e.g., automobiles, motorcycles, helicopters, airplanes, surface vessels, doors of these devices, windows thereof, engines thereof, alarms thereof, steering wheels thereof, brakes thereof, and so on), lighting devices (e.g., floor lights, ceiling lights, and portable lights), portable or stationary household devices (e.g., humidifiers, air cleaners, heaters, electric blankets, electric mattresses, air conditioners, and the like), and other remotely controllable industrial and/or household electric devices. It is appreciated that such target modules within the scope of this invention may be any of the above devices which may be designed to be controlled remotely or which may be modified or retrofit for such remote control.

Accordingly, the user may use various control modules of the communication control systems for controlling various operations of the target modules. For example, the user may turn on and/or off target modules by transmitting suitable command signals thereto with the control modules. In another example, the user may select one or multiple of a myriad of different operations of the target modules by transmitting appropriate command signals thereto by the control modules. In another example, the user may adjust extents of specific operations of the target modules by transmitting suitable command signals thereto with the control modules.

As used herein, a term “icon” is to represent any object which may be displayed on a display screen, either an object of a preset geometric shape, an alphanumeric character displayed thereon, a symbol displayed thereon, and the like. Such an “icon” is also preferably arranged to be selected by an user by various conventional means such as, e.g., clicking, double-clicking, and the like.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, the suitable methods and materials are described below. All publications, patent applications, patents, and/or other references mentioned herein are incorporated by reference in their entirety. In case of any conflict, the present specification, including definitions, will control. In addition, the materials, methods, and examples are illustrative only and not intended to be limiting.

Other features and advantages of the present invention will be apparent from the following detailed description, and from the claims.

### BRIEF DESCRIPTION OF THE DRAWING

FIGS. 1A to 1C are schematic perspective views of various mobile phone-type control modules of an exemplary communication control system according to the present invention;

FIGS. 1D to 1F are schematic perspective views of various PDA-shaped control modules of an exemplary communication control system according to the present invention;

FIGS. 2A and 2B are schematic top views of an exemplary control module with various touch screen-type input units according to the present invention;

FIGS. 2C and 2D are schematic top views of an exemplary control module with various display panel-type input units according to the present invention;

FIGS. 2E and 2F are schematic top views of an exemplary control module having various key-type input units according to the present invention; and

FIGS. 3A to 3D are schematic perspective views of target modules including various receivers according to the present invention.

### DETAILED DESCRIPTION OF THE PREFERRED EMBODIMENTS

The present invention generally relates to a communication control system which includes at least one control module and at least one target module and which is capable of wirelessly controlling various operations of the target module by the control module. More particularly, the present invention relates a communication control system including at least one prior art wireless communication device as its control module and at least one prior art household electric device as its target module and then allows wireless transmission of various command signals from the control module to the target module in order to control various operations of the target module. To this end, the control and target modules are preferably provided with various transmitters as well as receivers for receiving user inputs by the control modules, converting the user inputs to the command signals, transmitting the command signals to the target modules, and then recognizing and controlling the operations of the target module based on such command signals. The present invention, accordingly, relates to the control module including various transmitters capable of transmitting electromagnetic waves of a variety of frequency ranges which may be received and then recognized by the target module, and to the target module including various receivers capable of receiving and recognizing such electromagnetic waves defining various frequency ranges. The present invention further relates to the control modules provided with various input configurations not only for communicating with a third party as a wireless communication device but also for controlling the operations of the target module as a controller therefor.

The present invention relates to various methods of wirelessly controlling operation of a target module of a communication control system by a control module thereof. More particularly, the present invention relates to various methods of providing the communication control system by pairing at least one prior art wireless communication device which is to be utilized as a control module of the system with at least one prior art household electric device which is to be used as a target module of such a system, and then modifying at least one of the modules (or devices) for establishing various wireless control means from the control module to the target module. To this end, the present invention relates to various methods of incorporating into the control module various transmitters capable of transmitting electromagnetic waves of preset frequencies, various methods of incorporating into the target module various receivers capable of receiving and then recognizing command signals carried by the waves, various methods of modifying preexisting transmitters of the control module therefor, various methods of modifying preexisting receivers of the target module therefor, various methods of incorporating into the control module additional transmitters therefor, various methods of incorporating into such a target module additional receivers therefor, various methods of converting the waves of preset frequencies generated by the preexisting transmitters into other waves of different frequencies recognizable by the receivers and then transmitting such converted waves to the target module, and various methods of receiving the waves of preset frequencies from the control module, converting those waves into other waves of different frequencies, and then delivering the converted waves to the target module. The present invention also relates to various methods of receiving various user inputs for not only the communicating with the third party but also for such controlling using a single input unit of the control module, various methods of receiving the user inputs for such communication with one input unit and receiving different user inputs for the controlling with another input unit, and the like.

The present invention also relates to various processes for providing a communication control system including at least one control module and at least one target module, and capable of wirelessly controlling various operations of the target module by such a control module. In particular, the present invention relates to various processes for including at least one conventional wireless communication device as a control module of the system and including at least one prior art household electric device as its target module and then establishing wireless transmission of various command signals from the control module to the target module in order to control various operations of the target module. To this end, the present invention relates to various processes for providing the control module with at least one transmitter and also providing the target module with at least one receiver, various processes for providing the control module capable of transmitting the command signals receivable and recognizable by the target module, various processes for providing the target module capable of receiving and then recognizing the command signals emitted by the control module, and various processes of fabricating the target module to control its operations based on such command signals. Accordingly, the present invention also relates to various processes for providing various transmitters capable of transmitting electromagnetic waves of a variety of frequency ranges receivable and recognizable by the target module, and various processes for providing various receivers capable of receiving and recognizing such waves, and the like. The present invention also relates to various processes for providing such control modules with various input configurations not only for communicating with a third party while functioning as the wireless communication device but also for controlling the operations of the target module as the controller therefor.

Various aspects and/or embodiments of various systems, methods, and/or processes of this invention will now be described more particularly with reference to the accompanying drawings and text, where such aspects and/or embodiments thereof only represent different forms. Such systems, methods, and/or processes of this invention, however, may also be embodied in many other different forms and, accordingly, should not be limited to such aspects and/or embodiments which are set forth herein. Rather, various exemplary aspects and/or embodiments described herein are provided so that this disclosure will be thorough and complete, and fully convey the scope of the present invention to one of ordinary skill in the relevant art.

Unless otherwise specified, it is to be understood that various modules, units, elements, and/or parts of various systems of the present invention are not typically drawn to scales and/or proportions for ease of illustration. It is also to be understood that such members, units, elements, and/or parts of various systems of this invention designated by the same numerals may typically represent the same, similar, and/or functionally equivalent members, units, elements, and/or parts thereof, respectively.

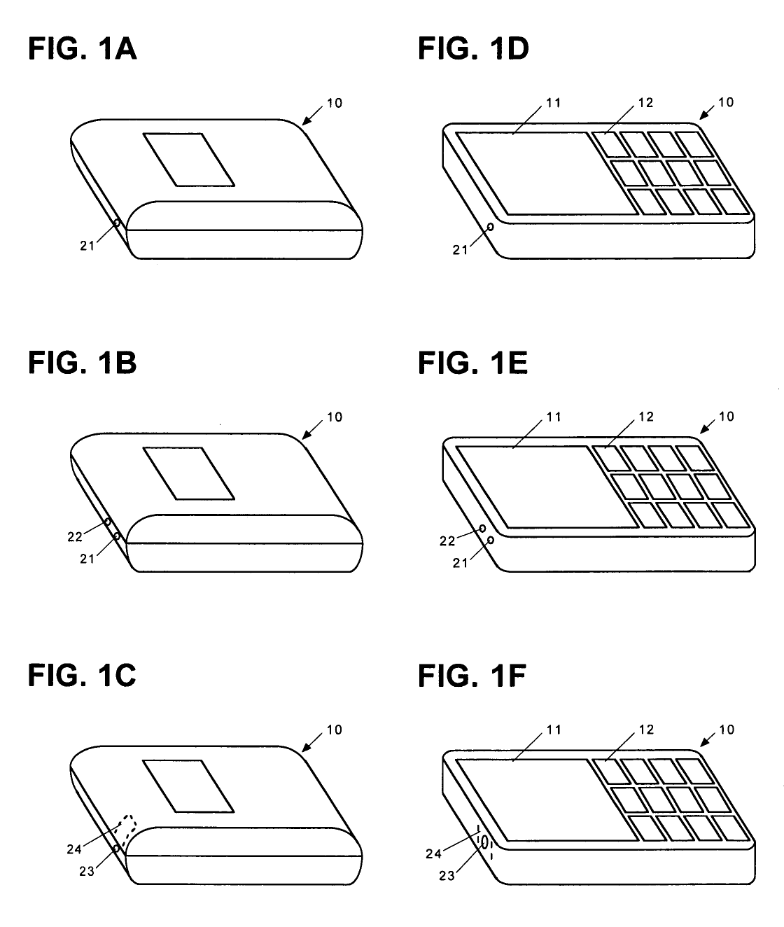

In one aspect of the present invention, various communication control systems are provided to transmit electromagnetic waves of various frequencies not only for wirelessly communicating with a third party directly and/or through a communication provider but also for wirelessly controlling at least one operation of an electric device. To this end and in one exemplary embodiment of such an aspect of the invention, a typical communication control system consists of at least one control module and at least one target module, where the control module is a prior art communication device while the target module is a novel electric device, where the control module is a novel communication device while the target device is a prior art electric device, where the control module is the novel communication device while the target module is also the novel electric device as well. In another exemplary embodiment of this aspect of the invention, such a communication control device consists only of at least one control module which is similar to a prior art communication device but is modified to be capable of wirelessly controlling the operation of the conventional electric device. In another exemplary embodiment of such an aspect of the invention, a communication control device consists only of at least one target module which is similar to a prior art electric device but is modified to receive various waves transmitted from a prior art communication device and to control its operation based thereon. In other words, various communication control systems of this invention may only include the novel control modules, may only include the novel target modules or, in the alternative, or may include not only the control modules but also the target modules. More particularly, not only the prior art communication devices but also novel communication devices which are modifications of the prior art counterparts may be employed as the control modules within the scope of this invention, where examples of such communication devices may include, but not be limited to, mobile phones, cellular phones, PDA's, beepers, walkie-talkies, and other wireless information processing devices, where such information may include, but not be limited to, text information, audio (or audible) information, video (or picture) information, and the like. Similarly, not only various prior art electric devices but also remotely controllable novel electric devices which are also modifications of the prior art counterparts may be employed as the target modules within the scope of the present invention, where examples of the electric devices may include, but not be limited to, storage devices of the above information, processing devices of such information, display (and/or playing) devices for such information, security devices, transportation devices such as automobiles, motorcycles, helicopters, airplanes, and surface vessels, lighting devices, household devices such as humidifiers, air cleaners, heaters, air conditioners, telephones, and other remotely controllable electric devices. Following FIGS. 1A to 1F, 2A to 2F, and 3A to 3F represent various exemplary embodiments of control and/or target modules of various communication control devices of this invention. It is to be understood, therefore, that each of these control and/or target modules may be used either alone or in combination, as long as the control modules may control at least one operation of such target modules. Further details of each of such control and target modules are to be provided.

In another aspect of the present invention, prior art mobile phone-type communication devices may be modified and then utilized as the control modules of the communication control systems of the present invention. FIGS. 1A to 1C show schematic perspective views of various mobile phone-type control modules of an exemplary communication control system according to the present invention. It is appreciated in these figures that only relevant portions of such mobile phone-type control modules are incorporated therein for ease of illustration and, therefore, that other portions thereof required for wireless communication are omitted therefrom.

In one exemplary embodiment of this aspect of the present invention, a communication control system includes a control module shaped and/or sized as a prior art mobile phone-type communication device. In one example of FIG. 1A, a control module 10 is characterized to include a single transmitter. Although not shown in the figure, the control module 10 includes various parts such as an audio input part, a video input part, and an input unit. The audio input part receives an audio or audible information such as a voice of an user (or other persons) and sounds from musical and/or other instruments, and transforms such audio information into electrical or optical signals. In this context, the audio input part may be provided from any conventional transducer capable of transforming acoustic waves of preset frequencies into such electrical or optical signals whichever may be processed by a circuitry of such a control module 10. The video input part receives a video or visible information such as a portrait of the user (or other persons) and background scenes, and then transforms such video information into electrical or optical signals. In this context, such a video input part may be provided from any prior art transducer capable of transforming visible light rays (or other electromagnetic waves) defining preset frequencies into such electrical or optical signals whichever may be processed by the circuitry of the control module 10. More particularly, such a video input part may acquire still pictures and/or dynamic video clips and transform such pictures and/or clips into the electrical or optical signals. The input unit receives various user inputs and relays such to a processor. The input unit may include multiple keys, at least one display, at least one touch screen, and the like, with which an user may provide desirable user inputs to the control module 10. It is appreciated that the input unit may acquire a text information provided by the user or, alternatively, the video input part may capture an image of a text and convert such an image into the text information. Regardless of an exact type of such informations, such input parts converts such informations into suitable electrical or optical signals. The processor receives the signals and manipulates such signals provided by the user based on such user inputs acquired by the input unit. For example, the processor superposes such input signals onto carrier waves by various prior art methods such as, e.g., by modulating amplitudes and/or frequencies of the carrier waves, by converting the signals into suitable waveforms and then directly combining such waveforms with the carrier waves, and the like, where details of this superposition are well known to one of ordinary skill in the field of signal transmission. The control module 10 also includes a transmitter 21 which may be disposed inside a body of the control module 10 or at least a portion of which may instead be exposed through the body as exemplified in this figure. The transmitter 21 is typically similar to those employed in the prior art communication devices and performs wireless transmission of electromagnetic waves of frequencies in ranges of, e.g., radio waves, microwaves, other waves of higher frequencies, and the like. Due to such transmission, such waves carrying therealong at least one of such informations may be transmitted to a similar wireless (or wired) communication device of a third party either directly or through a communication provider. When desirable, the control module 10 may include at least one receiver for receiving such waves transmitted by the similar wireless or wired communication device of the third party.

In operation, the user may perform the transmission of such waves carrying therealong such informations to the third party by providing suitable user inputs to the control module 10. The user may also provide at least one command signal to the control module 10 by its input unit, and transmits such radio waves and/or microwaves carrying the command signal therealong so at to control at least one operation of a target module (not included in the figure), where such waves may carry the command signal by using similar methods for carrying at least one of the above informations in the waves. The target module then receives such waves, extracts the command signal from such waves, and control at least one of its operations based upon the command signal. It is appreciated in this embodiment that the command signal is carried by the waves of those frequencies used for wireless communication. To the contrary, various household electric devices of such target modules are designed to wirelessly receive only those waves of frequencies in the range infrared waves. Therefore, this target module is preferably equipped with an auxiliary receiver or a converter, both of which are to be described in greater detail below.

In another example of FIG. 1B, a control module 10 is characterized to include therein a pair of transmitters. Although not included in the figure, the control module 10 also includes such parts as an audio input part, a video input part, an input unit, a processor, and a receiver, all of which are similar or identical to those of FIG. 1A. Contrary to that of FIG. 1A, however, this control module 10 includes two different transmitters 21, 22, where the first transmitter 21 is identical to that of FIG. 1A, while the second transmitter 22 is to function differently. More particularly, the first transmitter 21 performs the transmission of the radio waves or microwaves for the wireless transmission of at least one of such informations to the third party. To the contrary, the second transmitter 22 is arranged to transmit such waves of frequencies falling in the ranges of infrared waves. The processor is preferably arranged to superpose the command signal into the waves transmitted by the second transmitter 22 so that the infrared waves transmitted thereby carry the command signal therein. Therefore, any prior art target module equipped with an infrared receiver may readily receive the waves transmitted by this second transmitter 22 and readily control at least one of its operations based on the command signal carried in such waves. Other configurational and/or operational characteristics of the control module 10 of FIG. 1B are similar or identical to those of the control module of FIG. 1A, unless otherwise specified.

Still referring to the same embodiment and in another example of FIG. 1C, a control module 10 is characterized to include a single universal transmitter as well as a converter. Although not shown in the figure, the control module 10 includes such parts as an audio input part, a video input part, an input unit, a processor, a receiver, and the like, all of which may be similar or identical to those of FIG. 1A. In one example, the universal transmitter 23 is preferably arranged to transmit electromagnetic waves of frequencies over a wide range, e.g., spanning from the radio waves up to the infrared waves. To this end, the converter 24 may manipulate electric voltages and/or currents supplied to the universal transmitter 23, may manipulate various operating parameters of the universal transmitter 23 including, e.g., capacitance, resistance, and/or inductance of the entire universal transmitter 23 or those of only a portion thereof, and the like. Accordingly, the transmitter 23 may emit the low frequency waves for the transmission to the third party in one occasion or, alternatively, emit the higher frequency waves for the control of the target module in another occasion, where the processor may determine which frequencies the waves should be emitted depending on various user inputs. In another example, the universal transmitter 23 may be arranged to transmit first waves which may be only one of the radio waves, microwaves, and infrared waves in its default setting. This converter 24 is then arranged to convert the waves of preset frequencies transmitted by the universal transmitter 23 to second waves of different frequencies and to transmit such second waves to the target module. Accordingly, such a transmitter 23 may emit the first waves for the transmission to the third party in one occasion, while emitting such second waves for the control of the target module in another occasion. It is appreciated that selection of suitable frequencies of such waves in either example of this paragraph depends on various operational characteristics of the target module such as, e.g., operational characteristics of the receiver of the target module. As far as the control module 10 transmits the waves which carry therealong the command signal and which are receivable and recognizable by its receiver, the target module may receive any of such waves transmitted by the control module 10, extract the command signal therefrom, and then control at least one of its operations based on the command signal. Other configurational and/or operational characteristics of the control module 10 of FIG. 1C are also similar or identical to those of the control modules of FIGS. 1A and 1B, unless otherwise specified.

In another exemplary embodiment of this aspect of the invention, the above control modules of FIGS. 1A to 1C may be employed to control at least one operation of various target modules examples of which have been enumerated hereinabove. In one example, such control modules of FIGS. 1B and 1C may be used to control the operations of any remotely controllable prior art target module which is equipped with at least one infrared receiver. In another example, all of such control modules of FIGS. 1A to 1C may instead be used to control the operations of the target module which is equipped with at least one receiver for the radio waves or microwaves. Depending on the operational characteristics of the converter, the control module of FIG. 1C may be used to control the operations of other target modules capable of receiving the waves of frequencies outside the ranges of the radio waves and/or microwaves. In addition, the second transmitter of the control module of FIG. 1B may also be tailored to transmit the waves other than those radio waves, microwaves, infrared waves, and the like.

In another aspect of the present invention, prior art PDA-type communication devices may be modified and then utilized as the control modules of the communication control systems of the present invention. FIGS. 1D to 1F are schematic perspective views of various PDA-shaped control modules of an exemplary communication control system according to the present invention. It is also appreciated in these figures that only relevant portions of such PDA-type control modules are incorporated therein for ease of illustration and, therefore, that other portions thereof required for wireless communication are omitted therefrom.

In one exemplary embodiment of this aspect of the invention, a communication control system includes a control module shaped and/or sized as a prior art PDA-type communication device. In one example of FIG. 1D, a control module 10 is characterized to include a single transmitter. Although not included in the figure, the control module 10 includes various parts such as, e.g., an audio input part, a video input part, an input unit, a processor, and/or receiver, all of which are also similar or identical to those of FIG. 1A. In contrary to those exemplified in FIGS. 1A to 1C, the control module 10 includes a display panel 11 (or to be abbreviated as the “display” hereinafter) capable of displaying various text informations and/or video informations including various icons each designated for a specific function. In addition, such a control module 10 includes the input unit consisting of multiple keys 12 provided in a preset arrangement and receiving the user inputs required for the transmission of such informations to the third party as well as for the control of various functions of the target module. Similar to that of FIG. 1A, the control module 10 includes a single transmitter 21 designated to perform the transmission of such informations to the party as well as the control of various operations of the target module by transmitting those waves of frequencies in the ranges of microwaves or radio waves. Accordingly, such a target module is preferably equipped with the receiver and/or converter capable of extracting the command signal carried along by such microwaves or radio waves and controlling its operations based thereupon. Other configurational and/or operational characteristics of the control module 10 of FIG. 1F are similar or identical to those of the control module of FIG. 1A, unless otherwise specified.

In another example of FIG. 1E, a control module 10 is characterized to incorporate thereinto at least two transmitters. Although not shown in the figure, the control module 10 includes various parts such as, e.g., an audio input part, a video input part, an input unit, a processor, and a receiver, all of which are similar or identical to those of FIG. 1A, a display panel 11 and an input unit of multiple keys 12 which are similar to those of FIG. 1D, and the like. In addition, the control module 10 includes a pair of transmitters 21, 22 similar to those of FIG. 1B, where a first transmitter 21 emits the radio waves or microwaves carrying therealong at least one of such informations, whereas a second transmitter 22 transmits the infrared waves carrying the command signal therealong. Accordingly, the target module receives the infrared waves with its prior art receiver, extracts the command signal carried along by such infrared waves, and controls at least one of its operations based thereon. Other configurational and/or operational characteristics of the control module 10 of FIG. 1D are similar or identical to those of the control modules of FIGS. 1B and 1D, unless otherwise specified.

In another example of FIG. 1F, a control module 10 is characterized to include therein a single transmitter and a converter. Although not shown in the figure, the control module 10 includes various parts such as, e.g., an audio input part, a video input part, an input unit, a processor, and a receiver, all of which are similar or identical to those of FIG. 1A, an input unit and a display 11 which are similar to those of FIGS. 1D and 1E, and the like. Such a control module 10 includes an universal transmitter 23 and a converter 24 similar to those of FIG. 1C, where the converter 24 manipulates the transmitter 23 to transmit the microwaves or radio waves carrying therealong at least one of such informations in one occasion or, alternatively, to transmit the infrared waves carrying therealong the command signal in another occasion. Accordingly, the target module may receive the infrared waves with its prior art receiver, extract the command signal carried by the infrared waves, and control its operations based thereupon. Other configurational and/or operational characteristics of the control module 10 of FIG. 1F are similar or identical to those of the control modules of FIGS. 1A to 1E, unless otherwise specified.

In another exemplary embodiment of this aspect of the invention, the above control modules of FIGS. 1D to 1F may be employed to control at least one operation of various target modules examples of which have been enumerated hereinabove. In one example, such control modules of FIGS. 1E and 1F may be used to control the operations of any remotely controllable prior art target module which is equipped with at least one infrared receiver. In another example, all of such control modules of FIGS. 1D to 1F may instead be used to control the operations of the target module which is equipped with at least one receiver for the radio waves or microwaves. Depending on the operational characteristics of the converter, the control module of FIG. 1F may be used to control the operations of other target modules capable of receiving the waves of frequencies outside the ranges of the radio waves and/or microwaves. In addition, the second transmitter of the control module of FIG. 1E may also be tailored to transmit the waves other than those radio waves, microwaves, infrared waves, and the like.

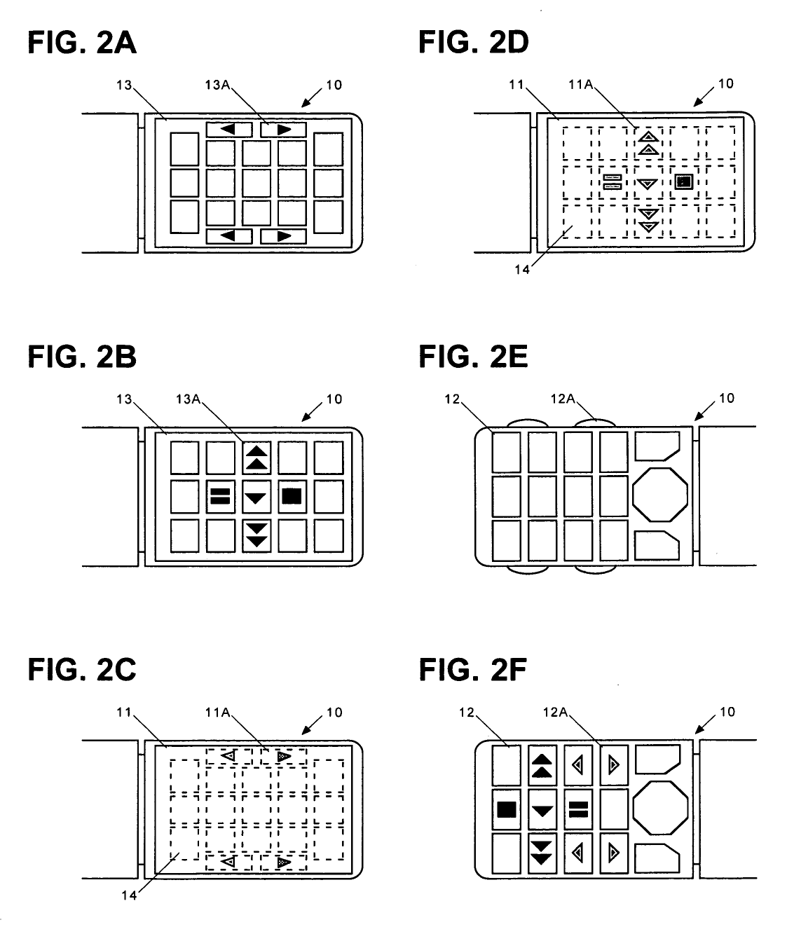

In another aspect of the present invention, various prior art touch screen-type input means of the wireless communication devices may be modified and then employed as the input units of various communication control systems of the present invention. FIGS. 2A and 2B are schematic top views of an exemplary control module including various touch screen-type input units according to the present invention. It is appreciated in all of these figures that only relevant portions of the control modules are incorporated therein for ease of illustration and, therefore, other portions thereof required for wireless communication are omitted therefrom.

In one exemplary embodiment of such an aspect of the invention and as exemplified in FIG. 2A, a communication control system includes a control module 10 characterized by its input unit of a single touch screen defining multiple portions thereover each of which is assigned with a different label and performs a different function. Although not included in the figure, the control module also 10 includes such parts as an audio input part, a video input part, a processor, a receiver, and the like, all of which are similar or identical to those shown in FIG. 1A. The control module 10 includes an input unit which is formed as a touch screen 13 which may be exposed through a body of such a module 10 or, in the alternative, may be hidden under a foldable cover (not included in the figure). Such a touch screen 13 defines thereover multiple portions 13A each of which is assigned with at least one label, receives an user input, and generates a control signal in response to the user input. The processor receives the control signal and performs a specific process designated by the control signal. More particularly, the touch screen 13 defines two groups of such portions 13A the first of which is specifically designated for receiving the user inputs related to the wireless transmission of at least one of such informations, while the second of which is specifically intended to receive the user inputs related to such control of various operations of the target module. In the embodiment exemplified in this figure, the portions 13A of the first group are generally disposed in a center region of the touch screen 13, while the portions 13A belonging to the second group are arranged along edges of the screen 13. Accordingly, the user may apply the user inputs to such portions 13A of different sets depending on his or her need for the transmission of the informations to the third party or for the control of various operations of the target module.

In operation, the user accesses the input unit of the control module 10. When the user desires to perform the wireless transmission of at least one of such informations to the third party, he or she provides the informations while also supplying necessary user inputs to the processor of the control module 10 by touching and/or pressing various portions 13A of the touch screen 13, generally those portions 13A clustered in the center region of the touch screen 13. When the user intends to perform the wireless control of the operations of the target module, the user then simply supplies the command signal by manipulating another set of portions 13A defined along the edges of the screen 13, without having to shift input modes of the control module 10. One of the above transmitters then transmits the microwaves, radio waves, and/or infrared waves to the target module which receives such waves, extracts the command signal from such waves, and controls its operations based upon the command signal. A major advantage of this embodiment lies in the fact that the user may choose and select any of such portions 13A depending upon his or her need. The flip side of this embodiment, however, is a need for defining a greater number of portions on the touch screen 13, some for such transmission of the informations and others for such wireless control of the target module.

In another exemplary embodiment of this aspect of the invention and as exemplified in FIG. 2B, a communication control system includes a control module 10 characterized by its input unit of a single touch screen similar to that of FIG. 2A but defining at least one common portion thereon. Although not included in the figure, the control module 10 includes various parts such as, e.g., an audio input part, a video input part, a processor, and/or a receiver, all of which may be similar or identical to those of FIG. 1A. The control module 10 includes an input unit of another touch screen 13 which may be exposed through its body or, in the alternative, may be hidden under a foldable cover (not shown in the figure). The touch screen 13 defines thereover multiple portions 13A each of which is assigned with at least one label, receives an user input, and generates a control signal in response to the user input so that the processor receives the control signal and performs a specific process designated by the control signal. In contrary to that of FIG. 2A, the touch screen 13 of this embodiment defines several portions 13A each of which is assigned with multiple labels and generates different control signals based on its input modes, where these portions 13A are to be referred to as the “common portions” hereinafter. Therefore, such common portions may receive the same user input but generates a first set of control signals for the wireless transmission of such informations to the third party in one occasion and then a second set of control signals for the wireless control of various operations of the target module in another occasion. In the embodiment exemplified in this figure, the common portions 13A are provided in a center region of the touch screen 13, although such common portions 13A may also be provided in other regions of the touch screen 13. Accordingly, the user may apply various user inputs to such common portions 13A depending on his or her need for the wireless transmission or wireless control by selecting a suitable input mode.

In operation, the user accesses the input unit of the control module 10. When the user desires to perform the wireless transmission of at least one of such informations to the third party, he or she sets the input mode for such transmission, provides the informations while also supplying necessary user inputs to the processor of the control module 10 by touching or pressing various portions 13A of the touch screen 13, including those common portions 13A when necessary. When the user intends to perform the wireless control of the operations of the target module, the user shifts the input mode to such control, and supplies the command signal by manipulating various portions 13A including such common portions 13A when desirable. One of the above transmitters then transmits the microwaves, radio waves, and/or infrared waves to the target module which receives such waves, extracts the command signal therefrom, and controls its operations based thereupon. A major advantage of such an embodiment is that the user may provide various user inputs and generate various control signals by defining only a limited number of portions 13A over the input unit. The flip side of this embodiment, however, is a need for shifting the input modes between one mode for such wireless transmission of the informations and another mode for the wireless control of various operations of the target module. Other configurational and/or operational characteristics of the control module 10 of FIG. 2B are similar or identical to those of the control module of FIG. 2A, unless otherwise specified.

It is to be understood in the input units of FIGS. 2A and 2B that any prior art touch screens may be employed to define those portions for acquiring the command signal. In one example, such a touch screen may be any conventional resistance-type device which includes a normal glass panel covered with at least one layer of a conductive material and at least one another layer of a resistive material, where these different layers are held apart by a spacer, a scratch-resistant layer may be disposed on top of the entire screen, and an electric current runs through these layers. When the user touches the screen, the conductive and resistive layers make contact in that exact spot and induces a change in electric fields generated by the current. A monitor registers such a contact, detects the change in the electric fields, and then assesses an exact coordinate of the point of contact, where the contact may be made by a finger of the user or by any other article. In another example, such a touch screen may be any prior art capacitance-type device including at least one layer which is placed over a glass panel and also capable of storing electric charges therein. As the user touches such a screen with a conductive article such as, e.g., his or her finger, an amount of the electric charges stored in the layer decreases while transferring some of the charges onto the user. A monitor registers such a contact, detects this change of charges using circuits located at each corner of the layer, and then assesses an exact coordinate of the point of contact based upon differences in the charges at the corners. In another example, the touch screen may be any prior art acoustic wave-type device which includes a pair of transducers which are disposed along the x- and y-axes of a glass plate, one of which sends acoustic waves, whereas another of which receives such waves. When the user touches the touch screen, propagation paths of such acoustic waves defined between such transducers are disturbed. A monitor registers such a contact, detects the disturbances along such paths, and then assesses an exact coordinate of the point of contact. Any of these prior art touch screens may be applied to the communication control system of the present invention as far as these prior art touch screens may be modified to define the above additional portions and/or common portions designated for such control of various operations of the target module.

In another aspect of the present invention, various prior art display panel-type input means of the wireless communication devices may be modified and then employed as the input units of various communication control systems of the present invention. FIGS. 2C and 2D are schematic top views of an exemplary control module including various display panel-type input units according to the present invention. It is appreciated in all of these figures that only relevant portions of the control modules are incorporated therein for ease of illustration and, therefore, other portions thereof required for wireless communication are omitted therefrom.

In one exemplary embodiment of such an aspect of the invention and as exemplified in FIG. 2C, a control module 10 is characterized to include an input unit of a single display panel displaying multiple icons each of which is assigned with a different label and performs a distinct function. Although not shown in the figure, the control module 10 may also include various parts such as, e.g., an audio input part, a video input part, a processor, and/or receiver, which are similar or identical to those of FIG. 1A. The control module 10 includes an input unit which is formed as a display panel 11 which is exposed through a body of the module 10 or, in the alternative, hidden under a foldable cover (not shown in the figure). The display panel 11 also displays thereon multiple icons 11A each of which is assigned with at least one label and receives an user input, e.g., when an user moves a cursor 14 thereto and clicks or double-clicks each of such icons 11A. Once selected, each icon 11A generates an unique control signal as a response to the user input, where the processor receives the control signal and performs a specific process designated thereby. More particularly, the display panel 11 displays two groups of such icons 11A the first of which is specifically designated for receiving the user inputs related to the wireless transmission of at least one of such informations, while the second of which is specifically intended to receive the user inputs related to such control of various operations of the target module. In the embodiment exemplified in this figure, the icons 11A of the first group are generally disposed in a center region of the display panel 11, while the icons 11A of the second group are arranged along edges of the panel 11. Accordingly, the user may apply the user inputs to such icons 11A of different sets depending on his or her need for the transmission of the informations to the third party or for the control of various operations of the target module.

In operation, the user accesses the input unit of the control module 10. When the user desires to perform the wireless transmission of at least one of such informations to the third party, he or she provides the informations while also supplying necessary user inputs to the processor of the control module 10 by selecting various icons 11A of the panel 11, generally those icons 11A clustered in the center region of the display 11. As the user intends to perform the wireless control of the operations of the target module, the user then simply supplies the command signal by manipulating another set of icons 11A defined along the edges of the panel 11, without having to shift input modes of the control module 10. One of such transmitters transmits the microwaves, radio waves, and/or infrared waves to the target module which receives the waves, extracts the command signal therefrom, and controls its operations based upon the command signal. A major advantage of this embodiment lies in the fact that the user may choose and select any of such icons 11A depending upon his or her need. The flip side of this embodiment, however, is a need for defining a greater number of icons 11A on the panel 11, some for the transmission while others for such control. Other configurational and/or operational characteristics of the control module 10 shown in FIG. 2C are similar or identical to those of the control modules of FIGS. 2A and 2B, unless otherwise specified.

In another exemplary embodiment of this aspect of the invention and as exemplified in FIG. 2D, a control module 10 is characterized to include an input unit of another display panel displaying multiple icons at least one of which is assigned with multiple labels and performs multiple functions. Although not included in this figure, the control module 10 includes various parts such as, e.g., an audio input part, a video input part, a processor, and/or receiver, all of which are also similar or identical to those of FIG. 1A. The control module 10 includes an input unit of another display panel 11 which is similarly exposed through its body or hidden under a foldable cover (not included in the figure). Such a panel 11 displays thereon multiple icons 11A each of which is assigned with at least one label, receives an user input, and generates a control signal when selected by the user so that the processor receives the control signal and performs a specific process designated by the control signal. In contrary to that of FIG. 2C, the display panel 11 of this embodiment has several icons 11A each of which is assigned with multiple labels and generates different control signals based upon its input modes, where these icons 11A are to be referred to as the “common icons” hereinafter. Accordingly, such common icons receive the same user input but generates a first set of control signals for such wireless transmission of the informations to the third party in one occasion and then a second set of control signals for such wireless control of various operations of the target module in another occasion. In the embodiment of this figure, the common icons 11A are provided in a center region of the display panel 11, although the common icons 11A may instead be provided in other regions of the panel 11. Therefore, the user may apply various user inputs to such common icons 11A depending upon his or her need for the wireless transmission or wireless control by selecting a suitable input mode.

In operation, the user accesses the input unit of the control module 10. When the user desires to perform the wireless transmission of at least one of such informations to the third party, he or she sets the input mode for such transmission, provides the informations while also supplying necessary user inputs to the processor of the control module 10 by selecting various icons 13A on the panel 11, including those common icons 11A when necessary. When the user intends to perform the wireless control of the operations of the target module, the user shifts the input mode to such control, and then supplies the command signal by selecting various icons 11A including such common icons 11A when desirable. One of such transmitters transmits the microwaves, radio waves or infrared waves to the target module which receives such waves, extracts the command signal therefrom, and controls its operations based thereupon. A major advantage of such an embodiment is that the user may provide various user inputs and generate various control signals by displaying only a limited number of icons 11A over the input unit. The flip side of such an embodiment, however, is a need for shifting the input modes between one mode for such wireless transmission and another mode for the wireless control of various operations of the target module. Other configurational and/or operational characteristics of the control module 10 of FIG. 2D are similar or identical to those of the control modules of FIGS. 2A to 2C, unless otherwise specified.

It is appreciated in the input units of FIGS. 2C and 2D that any prior art display devices may be employed to display those icons for acquiring the command signal from the user. In one example, the display panel may be any prior art LED-type device which includes multiple light emitting diodes which are provided in a preset arrangement and recruited to be turned on or off, thereby forming a desirable shape on the panel. In another example, the display panel may be any conventional LCD-type device which includes a layer of liquid crystals and multiple pixels thereof which may change their crystalline structure in response to an electric current which flows therein and/or to an electric voltage which is applied thereacross. In another example, the display panel may be any prior art OLED-type (or IOLED-type) device which includes at least one layer of organic (or inorganic) light emitting materials as well as multiple pixels thereof which may emit visible light rays as an electric current flows therethrough and/or as an electric voltage is applied thereacross. In another example, the display panel may be any prior art PDP-type display device which includes at least one layer of photon emitting material as well as their pixels which may emit visible light rays when an electric current flows therein and/or when an electric voltage is applied thereacross. Any of these and/or other prior art display devices may be employed by the communication control system of the present invention as long as such devices may be incorporated thereinto to define the above icons and/or common icons designated for such control of various operations of the target module.

In another aspect of the present invention, various conventional key-type input means of such wireless communication devices may be modified and utilized as the input units of the communication control systems of the present invention. FIGS. 2E and 2F are schematic top views of an exemplary control module having various key-type input units according to the present invention. It is appreciated in all these figures that only relevant portions of the control modules are incorporated therein for ease of illustration and, accordingly, other portions thereof required for wireless communication are omitted therefrom.

In one exemplary embodiment of such an aspect of the invention and as exemplified in FIG. 2E, a control module 10 is characterized to include an input unit of multiple keys each of which is assigned with a different label and performs a distinct function. Although not included in the figure, the control module 10 includes various parts such as, e.g., an audio input part, a video input part, a processor, a receiver, and the like, all of which are also similar or identical to those of FIG. 1A. The control module 10 includes an input unit consisting of multiple keys 12 which may be exposed through a body of the module 10 or, in the alternative, hidden under a foldable cover (not shown in the figure). These keys 12 are generally provided in various conventional arrangements as commonly seen in the prior art key pads of the mobile phones, PDA's, laptop computers, and the like. In general, each key 12 of such an input unit is assigned with at least one label, receives an user input, and generates a control signal in response thereto. The processor receives the control signal and performs a specific process which is designated thereby. More particularly, the input unit defines two groups of such keys 12 the first of which is specifically designated for receiving the user inputs related to the wireless transmission of at least one of such informations, while the second of which is specifically intended to receive the user inputs related to such control of various operations of the target module. In the embodiment shown in this figure, those keys 12 of the first group are generally disposed in a center region of the input unit, while the extra or additional keys 12A belonging to the second group are arranged along edges of the input unit. Accordingly, the user may apply various user inputs to such keys 12, 12A of different sets depending upon his or her need for such transmission or for such control of various operations of the target module.

In operation, the user accesses the input unit of the control module 10. When the user desires to perform the wireless transmission of at least one of such informations to the third party, he or she provides the informations while also supplying necessary user inputs to the processor of the control module 10 by pressing various keys 12 of the input unit, generally the keys 12 clustered in the center region of the input unit. When the user intends to perform the wireless control of the operations of the target module, the user simply supplies the command signal by manipulating another set of keys 12A defined along the edges of the input unit, without having to shift input modes of the control module 10. One of the above transmitters then transmits the microwaves, radio waves, and/or infrared waves to the target module which receives such waves, extracts the command signal from such waves, and controls its operations based upon the command signal. A major advantage of this embodiment lies in the fact that the user may choose and select any of such keys 12, 12A depending on his or her need. The flip side of this embodiment, however, is a need for incorporating a greater number of keys on the input unit, some for such transmission while others for such wireless control of such a target module. Other configurational and/or operational characteristics of the control module 10 of FIG. 2E are similar or identical to those of the control modules of FIGS. 2A to 2D, unless otherwise specified.

In another exemplary embodiment of this aspect of the invention and as exemplified in FIG. 2F, a control module 10 is characterized to include an input unit of multiple keys similar to those of FIG. 2E but including at least one common key therein as well. Although not included in the figure, the control module 10 includes various parts such as, e.g., an audio input part, a video input part, a processor, a receiver, and the like, all of which are also similar or identical to those of FIG. 1A. The input unit of the control module 10 includes multiple keys 12 which are exposed through its body or, in the alternative, hidden under a foldable cover (not shown in the figure). Each of the keys 12 is assigned with at least one label, receives an user input, and generates a control signal in response to the user input so that the processor receives the control signal and performs a specific process designated by the control signal. In contrary to that of FIG. 2E, the input unit of this embodiment defines several keys 12 each of which is assigned with multiple labels and generates different control signals depending upon its input modes, where such keys 12A are to be referred to as the “common keys” hereinafter. Therefore, the common keys receive the same user input but generates a first set of control signals for the wireless transmission of such informations to the third party in one occasion and then a second set of control signals for the wireless control of various operations of the target module in another occasion. In the embodiment depicted in this figure, the common keys 12A are provided in a center region of the input unit, although such common keys 12A may also be provided in other regions thereof. Therefore, the user may apply various user inputs to such common keys 12A depending on his or her need for the wireless transmission or wireless control by selecting a suitable input mode.

In operation, the user accesses the input unit of the control module 10. When the user desires to perform the wireless transmission of at least one of such informations to the third party, he or she sets the input mode for such transmission, provides the informations while also supplying necessary user inputs to the processor of the module 10 by pressing various keys 12 of the input unit, including those common keys 12A when necessary. When the user intends to perform the wireless control of the operations of the target module, the user shifts the input mode to such control, and then supplies the command signal by manipulating various keys 12 including the common keys 12A when desirable. One of the above transmitters then transmits the microwaves, radio waves, and/or infrared waves to the target module which receives such waves, extracts the command signal therefrom, and controls its operations based thereon. A major advantage of such an embodiment is that the user may provide various user inputs and generate various control signals by defining only a limited number of keys 12 of such an input unit. The flip side of this embodiment, however, is a need for shifting the input modes between one mode for such wireless transmission of the informations to the third party and another mode for the wireless control of various operations of the target module. Other configurational and/or operational characteristics of the control module 10 of FIG. 2F are similar or identical to those of such control modules of FIGS. 2A to 2E, unless otherwise specified.

It is to be understood in the input units of FIGS. 2E and 2F that any prior art keys and their key pads may be employed as the input unit of the communication control system of the present invention as far as these prior art keys and/or key pads may be modified to serve as the above additional keys and/or common keys designated for the control of various operations of the target module. The keys may also be provided in various prior art arrangements while simulating an arrangement of such keys for the prior art wireless communication device when used to perform the transmission but simulating another arrangement of those keys for the prior art household electric devices when used for control of various operations of such devices.

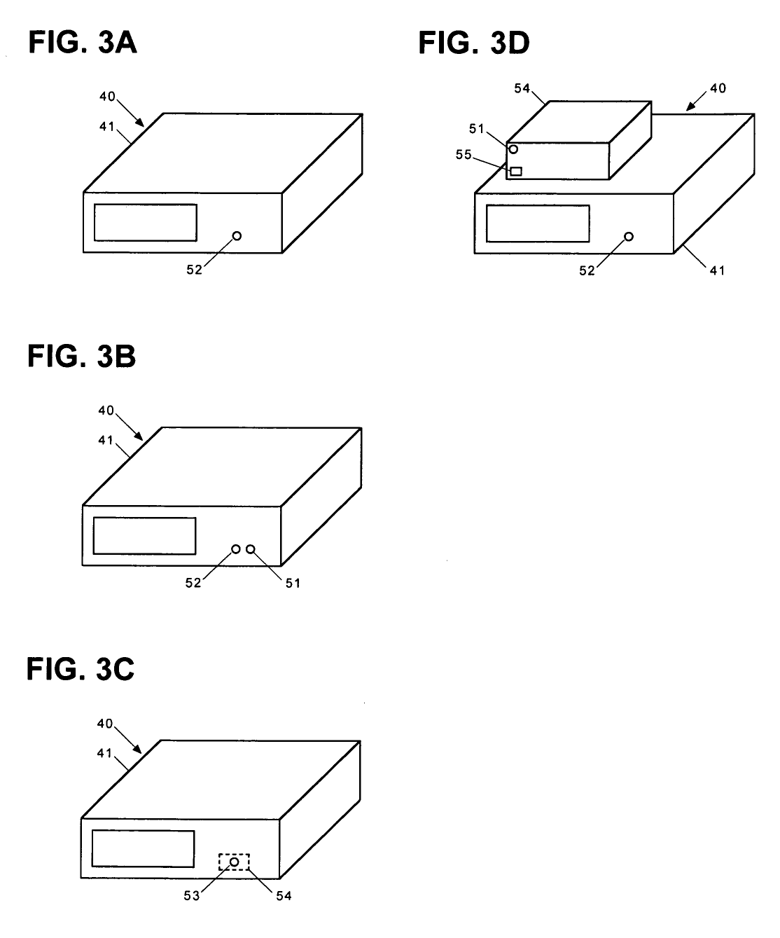

In another aspect of the present invention, remotely controllable prior art electric devices may be modified and selected as the target modules of the communication control systems of the present invention. FIGS. 3A to 3D represent schematic perspective views of target modules including various receivers according to the present invention. It is appreciated in these figures that the target modules are provided as typical audiovisual devices (e.g., VCR players, CD players, DVD players, and the like) and that only relevant portions of such target modules are incorporated therein for ease of illustration. Accordingly, other portions of such devices required for retrieving and replaying various audiovisual informations are omitted therefrom.

In one exemplary embodiment of this aspect of the present invention and as exemplified in FIG. 3A, a communication control system includes a target module which is shaped and/or sized as a prior art audiovisual device and characterized to include a single receiver. A typical target module 40 has a body 41 into which various circuitries and mechanical parts are incorporated to retrieve and/or replay various audiovisual informations which are stored therein a priori, stored in various prior art media for such informations, acquired through wireless broadcasting, acquired by downloads through a wired or wireless internet, and the like. The target module 40 also includes a receiver 52 which is disposed on a front of its body 41 and arranged to receive such electromagnetic waves of preset frequencies. When the control module of the system emits the infrared waves, the prior art infrared receiver 52 of the target module 40 may receive such waves from the control module, extract the command signal, and perform one or more operations only designated by the command signal. In this embodiment, the receiver may receive the infrared waves transmitted by a convention remote controller for the target module as well. When the control module emits the microwaves or radio waves, the target module 40 needs an additional receiver as will be described in conjunction with FIGS. 3B and 3C.

It is appreciated that the target module may control various operations thereof based upon the command signal transmitted by the control module. In one example, such a target module may be any storage device of any of the informations (e.g., a device with a magnetic storage disk, a device with an optical storage disk, a device with a semiconductor storage chip, and a device capable of storing any of such informations in any of such disks and/or chips) or a display and/or playing device of any of such informations (e.g., a magnetic disk driver, an optical disk driver, a microprocessor capable of driving any of such disks or storage chips, a device for retrieving any of the above informations from any of such storage devices without necessarily processing or modifying any of the informations), a processing device of any of such informations (e.g., a laptop compute, a PDA, a personal information or data organizer, an information processing device capable of sorting, selecting, rearranging, editing, modifying, and/or otherwise processing any of such informations stored therein and/or retrieved from various sources external thereto), and the like. In such a case, the command signal may be arranged to manipulate the target module to turn it on (or off), to select a type of such informations, to select a medium carrying such informations therein, to adjust various audiovisual qualities related to retrieval of such informations (e.g., a volume of sounds, a tone of such sounds, a color of images, a hue of such images, a speed of retrieval, and the like), to store the informations in the target module or other media for storing such informations, to erase the informations from the target module or other media carrying the informations, and the like. In addition, such a control module may transmit various waves carrying therealong other command signals for manipulating other functions of the target modules, where such functions are those typically found on various remote controllers for such target modules. In another example, the target module may be any security and/or surveillance device such as, e.g., a camera, a monitor, an actuator, a door, a lock, an alarm, and so on). The command signal may then be arranged to manipulate the target module to turn it on or off, to move the camera to a different location, to arm or disarm the alarm, and so on. In another example, such a target module may be any personal or public transportation device (e.g., an automobile, a motorcycle, a helicopter, an airplane, a surface vessel, a doors of these devices, its window, its engine, its alarm, its steering wheel, its brake, and the like). In this case, the control module may transmit the waves carrying the command signals to manipulate the target module to turn its engine on (or off), to open or close its window, to arm or disarm the alarm, to actuate the steering wheel or brake, and so on. In another example, such a target module may be any lighting device such as, e.g., a floor light, a ceiling light, a portable light, and the like. The control signal may then manipulate the target module to turn it on (or off), to adjust a brightness of the light, to adjust a direction in which such light is emitted, and so on. In another example, such a target module may be any portable or stationary household devices such as, e.g., humidifiers, air cleaners, heaters, electric blankets, electric mattresses, air conditioners, and the like. In this case, the command signal may then manipulate such a target module to turn it on or off, to adjust an extent of its operation, and the like. In short, the communication control system of this invention may be provided such that its control module may manipulate at least some or all operations of a specific target module which may be manipulated by any prior art remote controller of such a target module.

In another exemplary embodiment of this aspect of the present invention and as exemplified in FIG. 3B, a communication control system includes a target module which is also shaped and/or sized as a similar audiovisual device but characterized to include multiple receivers. A typical target module 40 has a body 41 in which various circuitries and mechanical parts are disposed for retrieving and/or replaying various audiovisual informations. The target module 40 of this embodiment includes a pair of receivers 51, 52 both of which are incorporated on a front of its body 41, where a first receiver 51 is arranged to receive the radio waves and/or microwaves, whereas a second receiver 52 is arranged to receive the infrared waves. Therefore, when the control module of this system emits the infrared waves carrying the command signal therealong, the second receiver 52 of the target module 40 may receive such waves from the control module, extract the command signal, and perform one or more operations designated by the command signal. Alternatively, when the control module emits the radio waves or microwaves carrying therealong the command signal, the first receiver 51 is then recruited to receive such waves from the control module, extract the command signal, and perform one or more operations which are designated by such a command signal. Other configurational and/or operational characteristics of the target module 40 of FIG. 3B are similar or identical to those of the target module of FIG. 3A, unless otherwise specified.

In another exemplary embodiment of this aspect of the present invention and as exemplified in FIG. 3C, a communication control system includes a target module which is also shaped and/or sized as a similar audiovisual device but characterized to include an universal receiver and a converter. A typical target module 40 has a body 41 in which various circuitries and mechanical parts are disposed for retrieving and/or replaying various audiovisual informations. The target module 40 also includes an universal receiver 53 which is incorporated into a front of its body 41, and a converter 54 which may be disposed inside or exposed through the body 41. Similar to the universal transmitters of the control modules of FIGS. 1C and 1F, the universal receiver 53 may also be provided in various embodiments. In one example, the universal receiver 53 is preferably arranged to receive electromagnetic waves of frequencies over wide ranges, e.g., spanning from the radio waves up to the infrared waves. To this end, the converter 54 may control electric voltages and/or currents supplied to the universal receiver 53 and/or may further manipulate various operating parameters of the universal receiver 53 including, e.g., capacitance, resistance, and/or inductance of the entire universal receiver 53 or those of only a portion thereof, and the like. Accordingly, the receiver 53 may receive the low frequency waves for the transmission to the third party in one occasion or, alternatively, may receive the higher frequency waves for the control of the target module in another occasion. The processor may determine which waves are received, how to extract the command signal therefrom, and the like. In another example, the universal receiver 53 may be arranged to receive first waves which may be only one of the radio waves, microwaves, and infrared waves in its default setting. This converter 54 is then arranged to convert the waves of preset frequencies received by the universal receiver 53 to second waves of different frequencies and to extract the command signal therefrom. Accordingly, such a receiver 53 receives and extracts the command signal from the first waves for the transmission to the third party in one occasion, while receiving and extracting the command signal from the second waves for such control of its operations in another occasion. It is appreciated that reception of suitable frequencies of such waves in either example of this paragraph depends on various operational characteristics of the control module such as, e.g., operational characteristics of various transmitters of the control module. As long as the target module 40 receives the waves which carry therealong the command signal and which are recognizable by its receiver, such a module 40 may receive any of such microwaves, radio waves, and/or infrared waves emitted by the control module, extract the command signal therefrom, and then control at least one of its operations based upon the command signal. Other configurational and/or operational characteristics of the target module 40 of FIG. 3C are similar or identical to those of the target modules of FIGS. 3A and 3B, unless otherwise specified.

In another exemplary embodiment of this aspect of the present invention and as exemplified in FIG. 3D, a communication control system includes a target module which is also shaped and/or sized as a similar audiovisual device and characterized to include an add-on converter. A target module 40 has a body 41 in which various circuitries and mechanical parts are incorporated for retrieving and/or replaying various audiovisual informations, and includes on a front of its body 41 a second receiver 52 which is identical to that of FIG. 3B and capable of receiving the infrared waves from the control module and/or its prior art remote controller. The target module 40 also includes an add-on converter 54 which functions similar to that of FIG. 3C and further includes a first receiver 51 and a transmitter 55, where the first receiver 51 is similar to that of FIG. 3B and capable of receiving the microwaves or radio waves, while the transmitter 55 is capable of transmitting the electromagnetic waves of various frequencies for communicating with the control module. Therefore, the target module 49 may receive the waves carrying the command signal therealong by the first and/or second receivers 51, 52, while the converter 54 converts the received waves into other waves of different frequencies as needed. Other configurational and/or operational characteristics of the target module 40 of FIG. 3D are similar or identical to those of the target modules of FIGS. 3A to 3C, unless otherwise specified.

Configurational and/or operational variations and/or modifications of the above aspects and/or embodiments of various exemplary communication control systems, their control modules, and/or their target modules described in FIGS. 1A to 3D also fall within the scope of this invention.

As briefly described above, the transmitters of the control module may be provided in various embodiments. For example, the control module may use its prior art transmitter for transmitting such waves carrying therealong the command signal, where such waves are typically the radio waves or microwaves of frequencies spanning up to several tens of gigahertz. In another example, the control module may include an additional transmitter which may transmit the infrared waves or other waves of different frequencies commonly employed in various prior art remotely controllable target modules and carrying therein such command signals. In another example, the control module may include the universal transmitter capable of emitting the waves of variable frequencies ranging from, e.g., such radio waves up to the infrared waves (or those waves of higher frequencies). As long as the target module is capable of receiving such waves and then extracting the command signal therefrom, any of such transmitters may be incorporated in the control module.

The control module generally requires the receiver for allowing a two-way transmission of the waves carrying therealong at least one of such informations between the user and third party. Such a receiver, therefore, is preferably tuned to receive the microwaves or radio waves commonly used for wireless audiovisual communication, and the control module may utilize the receiver of the prior art communication device. The control module may also utilize such a receiver to receive the waves transmitted by the target module for various purposes such as, e.g., interacting with the target module through such control of various operations of the target module and/or acquiring an input configuration of the input module of the control module which is to be provided in greater detail below. Similar to the case of various transmitters, the control module may use the prior art receiver for the transmission for these purposes as well, where such a receiver is preferably arranged to receive the infrared waves transmitted from the target module, where the target module is arranged to transmit the microwaves or radio waves, and the like. Alternatively, the control module may include an additional receiver capable of receiving the infrared waves from the target module and extracting the command signal therefrom. In addition, such a control module may instead include a converter which is similar to that of FIG. 3D. In short, the control and target modules may include any suitable receivers and transmitters as long as the control module may receive various waves transmitted by the target module and then extract any command signal carried therealong.

The receivers of various target modules may be provided in various embodiments as well. For example, the target module may use its prior art receiver for receiving the waves carrying therealong the command signals, where such waves are preferably the infrared waves. In another example, the target module may include an additional receiver which may receive the microwaves, radio waves or other waves of different frequencies commonly employed in various prior art remote controllers of the target modules and carrying therealong such command signals. In another example, the target module may include the universal receiver for receiving the waves of variable frequencies ranging from, e.g., such radio waves up to the infrared waves (or those waves of higher frequencies). As long as the control module is capable of transmit the waves from which the target module extracts the command signals, any of such receivers may be incorporated in the target module.

The target module may include the transmitter to allow the two-way transmission of the waves for various purposes such as, e.g., interacting with the control module through the control of various operations of the target module and/or providing a desirable input configuration to the input module of the control module. Similar to the case of various transmitters of the control module, the target module may include an additional transmitter capable of transmitting the radio waves, microwaves or infrared waves to the control module so that the control module may extract the input configuration therefrom. In addition, the target module may include a converter which is similar to that of FIG. 3D. In short, the control and target modules may include any suitable receivers and transmitters as long as the control module may receive various waves transmitted from the target module and then extract any desirable information carried therealong.

The target module may include at least one input unit which may receive various informations from the user and utilize such for such control of their operations by the control module. For example, the input unit may allow the user to provide various user inputs and then transmits such to the control module via various waves transmitted by the transmitter of the target module to the control module. In another example, the input may allow the user to manipulate the transmission of the input configuration to the control module so that the user may utilize such a configuration for proper control of operations of the target module. In general, such a target module includes at least one display unit for displaying various status of its operations. When desirable, the display unit of such a target module may also be recruited to display a status of control of such operations by the control module.

As described above, the control module may include various input units and allow the user to control such wireless transmission of the microwaves or radio waves carrying therein at least one of such informations, to perform such control of various operations of the target module by providing the command signals, and the like. In one example, the control module may allow the user to provide such command signals by the prior art input unit such as, e.g., various prior art keys, display panels, and/or touch screens. In another example, the control module may include at least one additional key, at least one additional display panel (and/or at least one icon to be displayed thereon), at least one additional touch screen (and/or at least one portion to be defined thereon), and the like, such that the user may provide the command signals using such additional (or extra) key, icon, portions, and the like. It is to be understood that such additional input means may define a different type from such prior art means so that the extra key may be disposed next to the prior art display panel, that the extra display panel may be incorporated to the control module along with the prior art keys, and the like.

Such input units of the control module may be provided with various input configurations with which the user may provide the command signals thereto. When the input unit includes at least one extra key on its keypad, at least one icon shown in its display panel, and/or at least one extra portion defined on its touch screen, these extra input means may be assigned with appropriate labels which may be easily distinguished from the rest of such means. However, when the input unit includes at least one common key, common icon, and/or common portion, such extra input means may preferably be distinguished from the rest of such means and may also be preferably provided in a suitable input configuration. Such common means (i.e., keys, icons, and/or portions) may be assigned with multiple labels and arranged to generate different control signals depending upon the input modes selected by the user, where the proper input mode may further be selected by manipulating a designated function key, by selecting a designated function icon on the display panel, by touching a designated portion of the touch screen, and the like.

The input configurations may also be provided to the control module or may be selected by the user in various embodiments. In one example, the control module may display a specific set of labels to such common means when a specific input mode is selected by the user. Accordingly, the control module may display those labels for such wireless transmission when the user selects a transmission mode, and may display different labels for such wireless control of the target module when the user selects a control mode. This embodiment is best suited when the input unit is the display panel which displays multiple icons and appends suitable labels next thereto. Accordingly, the control module may display a specific input configuration which may also be similar to that of a remote controller of a given target module. Such an embodiment may also be applicable when the input unit may display only one of different labels next to the common keys so that each key may be assigned with one key each time the user selects a specific input mode. In another example, the control module may display a specific set of icons or portions on the input unit when a specific input mode is selected by the user. The user may then directly apply the user inputs to the input unit and select a desired icon or portion therefrom. It is appreciated that this embodiment is typically feasible when the input unit includes the display panel which is also incorporated with the transparent touch screen.

Regardless of detailed mechanisms of selecting the desired key of the keypad, desired portion defined on the touch screen, and desired icon displayed on the display panel, the control module may acquire such input configurations in various methods. In one example, the control module may a priori be provided with such input configurations, and displays the suitable configuration whenever the user selects each input mode. This embodiment may be straightforward and easy to incorporate, although such an embodiment suffers from a major drawback in that the control module may be used to control those target modules of which input configurations are not stored in such a control module. In another example, such a control module may acquire the input configuration from an external source such as, e.g., a magnetic disk, a CD, a DVD, a semiconductor storage chip, and the like. This embodiment may allow the control module to control various operations of almost any target modules, but at the cost of requiring the control module to be equipped with a hardware capable of retrieving such requisite input configurations from the external source. In another example, the control module may acquire the input configurations by downloading such configurations through an internet, receiving such configurations through wireless transmission, and so on. In this embodiment, the control module may be arranged to store such configurations therein, to display such configurations in real time only during the control of such a target module (i.e., temporarily and without storing such), and the like.

As described above, the communication control system of the present invention may consist of only one of the control module and the target module, but not both. In one embodiment, the control module may include an appropriate input unit and an appropriate transmitter so that the user provides the control module with the command signals through the input configuration provided by the input unit and that the transmitter transmits the waves which carry the command signals therealong and which may further be received and analyzed by the target module. In this case, the control module may then constitute a sole part of the communication control system of this invention. In a reverse embodiment, the target module may include an appropriate receiver which may receive the electromagnetic waves transmitted by the control module, extract the command signals carried therealong, and control at least one of its operations based on such command signals. In this case, the target module may constitute a sole part of the communication control system of the present invention. In all other cases, however, the communication control system of this invention generally requires the control module and the target module, where the former is arranged to transmit the waves carrying therealong the command signals and where the latter is arranged to receive such waves, to extract the command signals therefrom, and to control its operations based thereupon.

Unless otherwise specified, various features of one embodiment of one aspect of the present invention may apply interchangeably to other embodiments of the same aspect of this invention and/or embodiments of one or more of different aspects of the present invention. Accordingly, any of such control modules disclosed in FIGS. 1A to 1F (and/or others which are not exemplified in those figures but disclosed in conjunction therewith) may employ any of such input units disclosed in FIGS. 2A to 2F (and/or others which are not exemplified in those figures but disclosed in conjunction therewith). In addition, any of such target modules disclosed in FIGS. 3A to 3D (and/or others which are not shown in those figures but disclosed in conjunction therewith) may also be controlled by any control modules disclosed in FIGS. 1A to 1F (and/or others which are not exemplified in those figures but disclosed in conjunction therewith). Moreover, any of the above input configurations may be incorporated into any of the input modules disclosed in FIGS. 2A to 2F (and/or others which are not shown in those figures but disclosed in conjunction therewith), may be obtained from any of the target modules disclosed in FIGS. 3A to 3D (and/or others which are not exemplified in those figures but disclosed in conjunction therewith), and the like.

It is to be understood that, while various aspects and/or embodiments of the present invention have been described in conjunction with the detailed description thereof, the foregoing description is intended to illustrate and not to limit the scope of the present invention, which is defined by the scope of the appended claims. Other embodiments, aspects, advantages, and modifications are also within the scope of the following claims.

What is claimed is:

1. A communication control system for wirelessly controlling its operations comprising:
at least one control module which is configured to acquire at least one of an audio information, a video information, and a text information, and to include therein at least one first transmitter, at least one second transmitter, and at least one input unit, wherein said first transmitter is configured to emit first waves defining first frequencies and carrying therealong at least one of said informations and to perform wireless transmission of said first waves to a different control module of a third party one of directly and through a communication provider, wherein said input unit is configured to acquire at least one command signal related to said operations from an user, and wherein said second transmitter is configured to emit second waves defining second frequencies and carrying therealong said command signal and to wirelessly transmit said second waves; and
at least one target module which is configured to be disposed away from said control module, to perform said operations not including said transmission, and to include therein at least one receiver which is configured to receive said second waves and then to extract said command signal from said second waves, whereby said target module performs at least one of said operations only designated by said command signal.

2. The system of claim 1, wherein said control module is one of a mobile phone, a cellular phone, a PDA, and a portable wireless communication device capable of performing said transmission.

3. The system of claim 1, wherein said target module is one of a display device of at least one of said informations, a replay device of said audio information, a storage device of at least one of said informations, and a processing device of said informations.

4. The system of claim 1, wherein said first frequencies are lower than said second frequencies.

5. The system of claim 1, wherein said first frequencies fall within ranges of at least one of radio waves and microwaves and wherein said second frequencies fall within ranges of infrared waves.

6. The system of claim 1, wherein said input unit is configured to include therein at least one of a plurality of keys, at least one touch screen, and at least one display, wherein each of at least two of said keys is configured to receive an user input, wherein said touch screen forms thereon a plurality of portions each of at least two of which is configured to receive said user input, and wherein said display is configured to display a plurality of icons each of which is configured to correspond to said user input when selected thereby.

7. The system of claim 6, wherein said input unit is configured to acquire at least one first user input provided by an user and related to said transmission in a first occasion and to acquire a second user input issued by said user but including at least one command signal related to said operations in a second occasion and wherein said second transmitter is configured to emit second waves defining second frequencies and carrying therealong said command signal and then to wirelessly transmit said second waves.

8. The system of claim 6, wherein said control module includes at least one first input unit and at least one second input unit in different portions thereof, wherein said first input unit is configured to receive a first user input provided by an user and related to said transmission, wherein said second input unit is configured to acquire a second user input including at least one command signal related to said operations and provided by said user, and wherein said second transmitter is configured to emit second waves defining second frequencies and carrying therealong said command signal, and then to wirelessly transmit said second waves.

9. The system of claim 6, wherein said control module includes at least one first input unit and at least one second input unit, wherein at least a portion of said first input unit is also configured to form at least a portion of said second input unit, wherein said first input unit is configured to receive a first user input issued by said user and related to said transmission, wherein said second input unit is also configured to acquire a second user input provided by said user but including at least one command signal related to said operations, and wherein said second transmitter is configured to emit second waves which have second frequencies and carry therealong said command signal and to wirelessly transmit said second waves.

10. A communication control system for wirelessly controlling its operations comprising:
at least one control module which is configured to acquire at least one of an audio information, a video information, and a text information and to include therein at least one input unit and at least one first transmitter, wherein said input unit is configured to acquire at least one command signal related to said operations and issued by an user, wherein said first transmitter is configured to emit first waves which define first frequencies and carry therealong at least one of said informations, and to perform wireless transmission of said first waves to a different control module of a third party one of directly and through a communication provider in a first occasion, and wherein said first transmitter is further configured to wirelessly transmit said first waves which define said first frequencies but carry said command signal therealong in a second occasion; and
at least one target module which is configured to be disposed away from said control module, to perform said operations not including said transmission, and to extract said command signal from said first waves, whereby said target module is configured to perform at least one of said operations only designated by said command signal.

11. The system of claim 10, wherein said target module is configured to also include at least one receiver which is configured to receive said first waves in said second occasion and to extract said command signal from said first waves.

12. The system of claim 10, wherein said target module is configured to also include at least one receiver and at least one converter, wherein said receiver is configured to receive said first waves and wherein said converter is configured to operatively couple with said receiver and to convert said first waves into second waves defining second frequencies in said second occasion.

13. The system of claim 10, wherein said input unit is configured to include therein at least one of a plurality of keys, at least one touch screen, and at least one display, wherein each of at least two of said keys is configured to receive an user input, wherein said touch screen forms thereon a plurality of portions each of at least two of which is configured to receive said user input, and wherein said display is configured to display a plurality of icons each of which is configured to correspond to said user input when selected thereby.

14. The system of claim 13, wherein said input unit is configured to acquire at least one first user input provided by an user and related to said transmission in a first occasion and to acquire a second user input issued by said user but including at least one command signal related to said operations in a second occasion and wherein said second transmitter is configured to emit second waves defining second frequencies and carrying therealong said command signal and then to wirelessly transmit said second waves.

15. The system of claim 13, wherein said control module includes at least one first input unit and at least one second input unit in different portions thereof, wherein said first input unit is configured to receive a first user input provided by an user and related to said transmission, wherein said second input unit is configured to acquire a second user input including at least one command signal related to said operations and provided by said user, and wherein said second transmitter is configured to emit second waves defining second frequencies and carrying therealong said command signal, and then to wirelessly transmit said second waves.

16. The system of claim 13, wherein said control module includes at least one first input unit and at least one second input unit, wherein at least a portion of said first input unit is also configured to form at least a portion of said second input unit, wherein said first input unit is configured to receive a first user input issued by said user and related to said transmission, wherein said second input unit is also configured to acquire a second user input provided by said user but including at least one command signal related to said operations, and wherein said second transmitter is configured to emit second waves which have second frequencies and carry therealong said command signal and to wirelessly transmit said second waves.

17. The system of claim 10, wherein said control module includes one of a mobile phone, a cellular phone, a PDA, and a portable wireless communication device for performing said transmission.

18. The system of claim 10, wherein said target module is one of a display device of at least one of said informations, a replay device of said audio information, a storage device of at least one of said informations, and a processing device of said informations.

19. A communication control system which includes therein at least one target module and at least one wireless communication device and which is also capable of wirelessly controlling operations of said target module by said device, wherein said device is configured to acquire at least one of a text information, an audio information, and a video information and to incorporate thereinto at least one first transmitter which is configured to emit first waves defining first frequencies and carrying therealong at least one of said informations and to perform wireless transmission of said first waves to a third party one of directly and through a communication provider and wherein said device is one of a mobile phone, a cellular phone, a PDA, and a portable wireless communication device capable of performing said transmission, said system comprising:
at least one input unit which is incorporated into said device and configured to acquire at least one command signal related to said operations and provided by said user;
at least one second transmitter which is disposed in said device and configured to generate second waves defining second frequencies and carrying therealong said command signal and to also wirelessly transmit said second waves to said target module; and
at least one receiver which is disposed in said target module disposed away from said device while performing said operations excluding said transmission and which is configured to receive said second waves and to extract said command signal from said second waves,
whereby said target module performs at least one of said operations only designated by said command signal.

20. The system of claim 10, wherein said target module is one of a display device of at least one of said informations, a replay device of said audio information, a storage device of at least one of said informations, and a processing device of said informations.
